(19) United States
(12) Patent Application Publication
(10) Pub. No.: US 2024/0059926 A1
(43) Pub. Date: Feb. 22, 2024

(54) COATING COMPOSITION COMPRISING A CARBAMATE-FUNCTIONAL POLY(ETHYLENE-ACRYLATE) COPOLYMER AND METHOD OF COATING SUBSTRATES

(71) Applicant: BASF Coatings GmbH, Müenster (DE)

(72) Inventors: Zhongliang ZHU, Troy, MI (US); Guergana TCHOLAKOVA, Southfield, MI (US); Donald H. Campbell, Hartland, MI (US); Werner-Alfons JUNG, Ascheberg (DE); Ivette Garcia Castro, Ludwigshafen (DE)

(21) Appl. No.: 18/259,621

(22) PCT Filed: Dec. 7, 2021
(86) PCT No.: PCT/EP2021/084517

§ 371 Date: Jun. 28, 2023

(30) Foreign Application Priority Data
Jan. 5, 2021 (EP) 21150246.3

(51) Int. Cl. C09D 123/36; C08J 7/046; B05D 7/00

(52) U.S. Cl. CPC C09D 123/36; C08J 7/046; B05D 7/536; B05D 2507/015; C08J 2323/08

(57) ABSTRACT

Disclosed herein are coating compositions including at least one carbamate-functional poly(ethylene-acrylate) copolymer as binder and at least one crosslinking agent, a method of coating substrates with such coating compositions and coated substrates obtained by the method. Further disclosed herein is a method of using such coating compositions for improving the scratch resistance of coating layers.

The present invention relates to coating compositions, particularly clearcoat compositions, comprising at least one carbamate-functional poly(ethylene-acrylate) copolymer as binder and at least one crosslinking agent, a method of coating substrates with such coating compositions and coated substrates obtained by said method. Moreover, the present invention relates to the use of such coating compositions for improving the scratch resistance of coating layers, particularly clearcoat layers.

### STATE OF THE ART

Basecoat/clearcoat (pigmented coating overlaid with a clearcoat layer) finishes for vehicles, such as automobiles and trucks, are currently being widely used. Typically, such finishes are produced by a wet-on-wet method. In the method for applying a basecoat/clearcoat finish, a basecoat (commonly referred to as a color coat) containing color pigments and/or special effect imparting pigments, is applied and flash dried for a short period of time, but not cured. Then the clear coating composition, which provides protection for the color coat and improves the gloss, distinctness of image and overall appearance of the finish, is applied thereover and both the color coat and the clearcoat are cured together. Optionally, the basecoat can be dried and cured before application of the clearcoat.

Scratching and marring of the clearcoat finish continue to be a problem for vehicle finishes. Clearcoat finishes on automotive vehicles are often subjected to mechanical damage caused by a variety of events during normal use. For example, materials that come in contact with the clearcoats under normal use on the roadways, such as stones, sand, metal objects and the like, cause chipping of the clearcoat finish. Keys used to lock and unlock vehicle doors, automated car wash equipment and brushes as well as the placement of sliding objects on the surface of an automotive vehicle such as the top of a trunk or hood causes scratches and marring. Also, the clearcoat finish is subject to environmental damage caused, for example, by acid rain and exposure to UV light.

Typically, a harder more highly crosslinked film exhibits improved scratch resistance, but it is less flexible and much more susceptible to chipping or thermal cracking due to embrittlement of the film resulting from the high crosslink density. A softer, less crosslinked film, while not prone to chipping or thermal cracking, is susceptible to scratching, waterspotting, and acid etch due to a low crosslink density of the cured film.

Further, elastomeric automotive parts and accessories, for example, elastomeric bumpers and hoods, are typically coated “off-site” and shipped to automobile assembly plants. The coating compositions applied to such elastomeric substrates are typically formulated to be very flexible so the coating can bend or flex with the substrate without cracking. To achieve the requisite flexibility, coating compositions for use on elastomeric substrates often are formulated to produce coatings with lower crosslink densities or such coating compositions include flexibilizing adjuvants which lower the overall film glass transition temperature (T_{g}). While acceptable flexibility properties can be achieved with these formulating techniques, they also can result in softer films that are susceptible to scratching. Consequently, great expense and care must be taken to package the coated parts to prevent scratching of the coated surfaces during shipping to automobile assembly plants.

Despite recent improvements in the scratch resistance of clearcoat systems, there remains a need in the automotive coatings art for clearcoats to have good initial scratch resistance as well as enhanced post-weathering (“retained”) scratch resistance without embrittlement of the film due to high crosslink density. Moreover, it would be advantageous to provide clearcoats for elastomeric substrates utilized in the automotive industry which are both flexible and resistant to scratching.

### OBJECT

Accordingly, the object of the present invention is to provide a coating composition suitable as clear coating composition in OEM finishes and automotive refinishes, which results in coating layers having improved scratch resistance, while at the same time maintaining a good overall appearance. In addition, the coating compositions should already have a high degree of scratch resistance immediately after thermal curing and in particular form coating layers having a high level of gloss retention after scratch exposure. Moreover, coatings and coating systems, in particular clearcoat systems, should be able to be formed even with film thicknesses greater than 40 μm without generating stress cracks. This is an important requirement for the use of coatings and coating systems, in particular clearcoat systems, in the technical and aesthetically demanding fields of automotive OEM finishing and refinishing. Furthermore, the new coating compositions ought to be easily preparable with very good reproducibility and ought to have a high storage stability.

### Technical Solution

The objects described above are achieved by the subject matter claimed in the claims and also by the preferred embodiments of that subject matter that are described in the description hereinafter.

A first subject of the present invention is therefore a coating composition comprising:
a) at least one binder B containing at least one carbamate group, said binder B being prepared by reacting at least one ethylene copolymer EC with at least one carbamate compound in the presence of at least one catalyst, said ethylene copolymer EC comprising—in polymerized form—
   i. 10 to 80 wt. % of ethylene;
   ii. 1 to 90 wt. % of at least one polymerizable compound C1 having at least one hydroxyl group; and
   iii. 0 to 80 wt. % of at least one further polymerizable compound C2 being different from compound C1; and
b) at least one crosslinking agent CA.

The above-specified coating composition is hereinafter also referred to as coating composition of the invention and accordingly is a subject of the present invention. Preferred embodiments of the coating composition of the invention are apparent from the description hereinafter and also from the dependent claims.

In light of the prior art it was surprising and unforeseeable for the skilled worker that the object on which the invention is based could be achieved by using a carbamate-functional ethylene copolymer as binder in combination with a crosslinking agent having suitable complementary reactive groups in the coating composition. The partial replacement of carbamate-functional (meth)acrylic resins with the carbamate-functional ethylene copolymer in coating compositions results in coating layers having an improved scratch resistance as compared to coating layers being prepared from coating compositions only comprising carbamate-functional (meth)acrylic resins. However, the excellent optical appearance is not negatively influenced by the replacement with the carbamate-functional ethylene copolymer. Additionally, the inventive coating compositions allow to prepare coating layers in high film thicknesses of more than 40 μm without the occurrence of stress cracks, thus rendering them especially suitable for OEM automotive finishing and refinishing applications. Moreover, the inventive coating compositions can be easily prepared and show a high storage stability.

A further subject of the present invention is a method for producing at least one coating on a substrate, comprising
(1) optionally applying a pigmented basecoat composition to the substrate, forming a coating film from said basecoat composition and optionally curing said basecoat film;
(2) applying an inventive coating composition to the substrate or the coated substrate obtained after step (1);
(3) forming a coating film from the composition applied in step (2); and
(4) curing the coating film(s) obtained after step (1) and/or (3).

Another subject of the present invention is a coated substrate obtained by the inventive method.

A final subject of the present invention is the use of an inventive coating composition for improving the scratch resistance of coating layers, especially of clearcoat layers.

### DETAILED DESCRIPTION

The measurement methods to be employed in the context of the present invention for determining certain characteristic variables can be found in the Examples section. Unless explicitly indicated otherwise, these measurement methods are to be employed for determining the respective characteristic variable. Where reference is made in the context of the present invention to an official standard without any indication of the official period of validity, the reference is implicitly to that version of the standard that is valid on the filing date, or, in the absence of any valid version at that point in time, to the last valid version.

The term “ethylene copolymer” refers to polymers derived from ethylene and at least one further monomer which can be polymerized with ethylene under suitable reaction conditions. Preferably, said at least one further monomer therefore contains at least one unsaturated moiety. Consequently, the term “polymerizable compound” in connection with compounds C1 and C2 refers to a compound, preferably a monomer, which can be polymerized with ethylene under suitable reaction conditions. Preferably, said compounds C1 and C2 therefore each contain at least one unsaturated moiety.

The term “crosslinking agent” refers to compounds having at least one functional group with can undergo a chemical reaction with the functional groups present in the binder B, preferably carbamate groups and optionally hydroxyl groups, under suitable reaction conditions, thus leading to a crosslinking of the binder B. If further binders B1, which are different from binder B are present, said crosslinking agent might also undergo crosslinking reactions with functional groups present in said further binder B1. In the latter case, the inventive coating composition may also contain further crosslinking agents which only undergo chemical reactions with the functional groups of the further binder B1,

The term “(meth)acrylate” refers both to acrylates and to methacrylates. (Meth)acrylates may therefore be composed of acrylates and/or methacrylates and may comprise further ethylenically unsaturated monomers such as styrene or acrylic acid, for example.

All film thicknesses reported in the context of the present invention should be understood as dry film thicknesses. It is therefore the thickness of the cured film in each case. Hence, where it is reported that a coating material is applied at a particular film thickness, this means that the coating material is applied in such a way as to result in the stated film thickness after curing.

All temperatures elucidated in the context of the present invention should be understood as the temperature of the room in which the substrate or the coated substrate is located. It does not mean, therefore, that the substrate itself is required to have the temperature in question. If room temperature is denoted in the following, this should be understood as a temperature ranging from 20 to 25° C.

Inventive Coating Composition:

Binder B:

The inventive coating composition comprises as first mandatory component (a) at least one binder B, comprising at least one carbamate group. The term “binder” the sense of the present invention and in agreement with DIN EN ISO 4618 (German version, date: March 2007), refers preferably to those curable nonvolatile fractions of the coating composition which are responsible for forming the film upon curing, with the exception of any pigments and fillers therein, and more particularly refers to the binder B and further resins optionally present which can be cured either by physical drying or by chemical crosslinking. Thus, the term “binder” in the sense of the present invention does not encompass curing agents or crosslinking agents used to crosslink the binders to effect film formation.

Said carbamate-functional binder B is prepared by reacting at least one ethylene copolymer EC with at least one carbamate compound in the presence of at least one catalyst, said ethylene copolymer EC comprising—in polymerized form—
i. 10 to 80 wt. % of ethylene;
ii. 1 to 90 wt. % of at least one polymerizable compound C1 having at least one hydroxyl group; and
iii. 0 to 80 wt. % of at least one further polymerizable compound C2 different from compound C1.

Where it is stated in the context of the present invention that the ethylene copolymer EC comprises components i., ii. and optionally iii. in polymerized form, this means that these particular components are used as starting compounds for the preparation of the ethylene copolymer in question. Since ethylene can be polymerized with further monomers comprising unsaturated moieties, the ethylene copolymer preferably comprises the unsaturated moieties, previously present in ethylene and the further monomer(s), in the form of C—C single bonds, in other words in their correspondingly reacted form.

With particular preference, the ethylene copolymer EC consists of the aforementioned components i., ii. and optionally iii., and therefore does not comprise any further compounds.

The ethylene copolymer EC is preferably prepared in a continuous high-pressure polymerization process. The term “high-pressure continuous polymerization process” refers, in the context of this invention”, to a polymerization process comprising a continuous feed of the starting materials i., ii., optionally iii. and optionally at least one chain transfer agent and/or solvent listed below (also called monomer feed hereinafter) and a continuous output of the produced ethylene copolymer EC at a pressure of 1,000 to 4,000 bar. The polymerization process may continue for at least 3 h, preferably at least 24 h, and in particular at least 72 h.

The polymerization process may be carried out in stirred high-pressure autoclaves, hereinafter also referred to as high-pressure autoclaves, or in high-pressure tube reactors, hereinafter also referred to as tube reactors. Preference is given to the high-pressure autoclaves, which may have a length/diameter ratio in the range from 5:1 to 30:1, preferably from 10:1 to 20:1.

The polymerization process may be carried out at a pressure in the range from 1,000 to 4,000 bar, preferably from 1,200 to 2,500 bar, and particularly 1,500 to 2,200 bar. It is possible to change the pressure during the polymerization either gradually or suddenly within the afore-stated ranges.

The polymerization process may be carried out at a reaction temperature in the range of 150 to 300° C., preferably 170 to 250° C., and in particular 190 to 230° C.

The monomer feed comprises the ethylene, the at least one polymerizable compound C1, optionally the at least one polymerizable compound C2, optionally at least one chain transfer agent and/or at least one solvent. The ethylene, compound C1, optionally compound C2 can be mixed before, during, or after entering the high-pressure autoclaves or the high-pressure tube reactors with further compounds and solvents listed below. Preferably, ethylene, compound C1, optionally compound C2 and the chain transfer agent listed below are mixed before entering the high-pressure autoclaves. Typically, the polymerization process takes place in the polymerization zone, which is usually inside the high-pressure autoclave or the high-pressure tube reactor. Mixing of the aforestated compounds and solvents before entering the high-pressure autoclave or reactor can be performed in the middle zone pressure of 200 to 300 bar and is called mixing within the compressor. Mixing within the compressor results in an increased homogeneity of the obtained mixture. Alternatively, all liquid compounds (i.e. compressed liquid ethylene, compound C1, optionally C2, chain transfer agent and solvents) can be directly added to the high-pressure zone of 1,000 to 4,000 bar (called mixing outside of the compressor). In addition, both ways to add the liquids components can be used simultaneously.

Preferably, the monomer feed is free of an initiator, preferably free of an initiator suitable for radical polymerization as listed below.

The monomer feed comprises the ethylene, compound C1 and optionally C2 in amounts which are suitable to arrive at the amounts previously listed in connection with the ethylene copolymer.

Usually, the monomer feed comprises at least 15 wt. %, preferably at least 20 wt. %, and in particular at least 30 wt. % of ethylene, based in each case on the total weight of the monomer feed. In another form, the monomer feed comprises 30 to 98 wt. %, preferably 40 to 95 wt. %, and in particular 50 to 70 wt. % or from 70 to 85 wt. % of ethylene, based on the total weight of the monomer feed.

Usually, the monomer feed comprises at least 10 wt. %, preferably at least 25 wt. %, and in particular at least 35 wt. % of polymerizable compound C1 comprising at least one hydroxy group, where the percentage is based on the total weight of the monomer feed. In another form the monomer feed comprises at least 5 wt. %, preferably at least 8 wt. %, and in particular at least 12 wt. % of polymerizable compound C1 comprising at least one hydroxy group, where the percentage is based on the total weight of the monomer feed. In another form, the monomer feed comprises 10 to 70 wt. %, preferably 20 to 60 wt. %, and in particular 36 to 55 wt. % of polymerizable compound C1 comprising at least one hydroxy group.

The monomer feed may comprise up to 10 wt. %, preferably up to 20 wt. %, more preferably up to 30 wt. %, very preferably up to 40 wt. %, of at least one polymerizable compound C2, wherein the percentage is based on the total weight of the monomer feed. In another form, the monomer feed comprises 5 to 70 wt. %, preferably 10 to 60 wt. %, and in particular 15 to 55 wt. % of at least one polymerizable compound C2.

The conversion of the ethylene is usually around 10 to 50 wt. %, preferably 20 to 45 wt. % and in particular 25 to 45 wt., based in each case on the ethylene feed. The input (e.g. kg monomer feed per hour) and the output (e.g. kg ethylene copolymer EC) per hour) of the polymerization process depend on the size of the equipment. For example, a 1 liter autoclave may allow an input of 6 to 25 kg/h monomer feed, or an output of 3 to 8 kg/h ethylene copolymer EC.

The polymerization of the ethylene, compound C1 and optionally compound C2 is usually carried out in the presence of at least one chain transfer agent. Suitable chain transfer agents in the sense of this invention are compounds which terminate the polymerization reaction by being incorporated as terminus of the copolymer chain. Suitable chain transfer agents are selected from saturated or unsaturated hydrocarbons, aliphatic ketones, aliphatic aldehydes, hydrogen, or mixtures thereof. The term “aliphatic” as used herein includes the term “cycloaliphatic” and refers to non-aromatic groups, moieties and compounds, respectively.

Among saturated and unsaturated hydrocarbons the chain transfer agents can be selected from pentane, hexane, cyclohexane, isododecane, propene, butene, pentene, cyclohexene, hexene, octene, decen and dodecen, and from aromatic hydrocarbons such as toluene, xylol, trimethyl-benzene, ethylbenzene, diethylbenzene, triethylbenzene, mixtures thereof.

Suitable ketones or aldehydes as chain transfer agents are aliphatic aldehydes or aliphatic ketones, such as compounds of general formula (I)

R¹—C(O)—R² (I)

wherein
R¹ and R² are, independently from each other selected from
   hydrogen;
   C₁-C₆-alkyl groups, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl and sec-hexyl groups, more preferably C₁-C₄-alkyl groups such as methyl, ethyl, n-propyl, isopropyl, n-butyl, isobutyl, sec-butyl and tert-butyl groups; or
   C₃-C₁₂-cycloalkyl groups such as cyclopropyl, cyclobutyl, cyclopentyl, cyclohexyl, cycloheptyl, cyclooctyl, cyclononyl, cyclodecyl, cycloundecyl and cyclododecyl groups, more preferably cyclopentyl, cyclohexyl and cycloheptyl groups.

The R¹ and R² residues may also be covalently bonded to one another to form a 4- to 13-membered ring. For example, R¹ and R² may form the following alkylene groups: —(CH₂)₄—, —(CH₂)₅—, —(CH₂)₆—, —(CH₂)₇—, —CH(CH₃)—CH₂—CH₂—CH(CH₃)— or —CH(CH₃)—CH₂—CH₂—CH₂—CH(CH₃)—.

Preferred ketones as chain transfer agents are acetone, methylethylketone, diethylketone and diamylketone. Preferred aldehydes as chain transfer agents are acetaldehyde, propionaldehyde, butanal and pentanal.

Among alcohols the chain transfer agents are selected from the group consisting of methanol, ethanol, propanol, isopropanol, butanol and pentanol.

Among thiols the chain transfer agents maybe selected from mercaptoethanol to tetrade-canthiol. In another form suitable thiols are organic thio compounds, such as primary, secondary, or tertiary aliphatic thiols, such as, ethanethiol, n-propanethiol, 2-propanethiol, n-butanethiol, tert-butanethiol, 2-butanethiol, 2-methyl-2-propanethiol, n-pentanethiol, 2-pen-tanethiol, 3-pentanethiol, 2-methyl-2-butanethiol, 3-methyl-2-butanethiol, n-hexanethiol, 2-hexanethiol, 3-hexanethiol, 2-methyl-2-pentanethiol, 3-methyl-2-pentanethiol, 4-methyl-2-pentanethiol, 2-methyl-3-pentanethiol, 3-methyl-3-pentanethiol, 2-ethylbutanethiol, 2-ethyl-2-butanethiol, n-heptanethiol and its isomeric compounds, n-octanethiol and its isomeric compounds, n-nonanethiol and its isomeric compounds, n-decanethiol and its isomeric compounds, n-undecanethiol and its isomeric compounds, n-dodecanethiol and its isomeric compounds, n-tridecanethiol and its isomeric compounds, substituted thiols, such as 2-hydroxyethanethiol, aromatic thiols, such as benzenethiol, ortho-, meta-, or para-methyl-benzenethiol, mercaptoalkanoic acid and derivatives thereof, such as 6-methylheptyl 3-mercaptopropionate or 2-ethylhexyl 2-mercaptoethanoate.

Among amines the chain transfer agents are selected from primary, secondary, or tertiary amines, such as dialkyl amines or trialkyl amines. Examples for amines are propyl amine, dipropyl amine, dibutyl amine, triethyl amine.

Preferred chain transfer agents are aliphatic aldehydes and/or aliphatic ketones and/or hydrogen. Particularly preferred chain transfer agents are propionaldehyde and/or methylethylketone and/or hydrogen.

The weight ratio of propionaldehyde to methylethylketone may be in the range from 4:1 to 1:4, preferably from 3.5:1 to 1:3.0, in particular from 2.8:1 to 1:2.5

The monomer feed comprising the ethylene, compound C1 and optionally compound C2 may be polymerized in the presence of at least 2 wt. % of chain transfer agent, based on the total weight of the monomer feed. The chain transfer agent may be used in amounts of 4 to 28 wt. %, preferably 6 to 23 wt. %, and in particular 9 to 13 wt. % or 13 to 20 wt. %, based in each case on the total weight of the monomer feed.

The chain transfer agents can be diluted with suitable solvents (e.g. hydrocarbons), preferably they are used without additional solvents.

The polymerization process is usually a free-radical polymerization and thus initiated by an initiator. Suitable initiators are organic peroxides, oxygen or azo compounds. Mixtures of a plurality of free-radical initiators are also suitable.

Suitable peroxides are didecanoyl peroxide, 2,5-dimethyl-2,5-di(2-ethylhexanoylperoxy)hexane, tert-amyl peroxypivalate, tert-amyl peroxy-2-ethylhexanoate, dibenzoyl peroxide, tert-butyl peroxy-2-ethylhexanoate, tert-butyl peroxydiethylacetate, tert-butyl peroxydiethylisobutyrate, 1,4-di(tert-butylperoxycarbonyl)cyclohexane as isomer mixture, tert-butyl perisononanoate, 1,1-di(tert-butylperoxy)-3,3,5-trimethylcyclohexane, 1,1-di(tert-butylperoxy)cyclohexane, methyl isobutyl ketone peroxide, tert-butyl peroxyisopropylcarbonate, 2,2-di(tert-butylperoxy)butane or tert-butyl peroxacetate; tert-butyl peroxybenzoate, di-tert-amyl peroxide, dicumyl peroxide, the isomeric di-(tert-butylperoxyisopropyl)benzenes, 2,5-dimethyl-2,5-di-tert-butylperoxyhexane, tert-butyl cumyl peroxide, 2,5-dimethyl-2,5-di(tert-butylperoxy)hex-3-yne, di-tert-butylperoxide, 1,3-diisopropylbenzene monohydroperoxide, cumene hydroperoxide or tert-butyl hydro-peroxide, or dimeric or trimeric ketone peroxides.

As azo compound azodicarboxylic esters, azodicarboxylic dinitriles are suitable, mention may be made by way of example of azobisisobutyronitrile (“AIBN”).

Preferred initiators are selected from the group consisting of di-tert-butyl peroxide, tert-amyl peroxypivalate, tert-butyl peroxypivalat, tert-butyl peroxyisononanoate, tert-butyl peroxy-2-ethylhexanoate, 2,2-di(tert-butylperoxy)butane and mixtures thereof. Preferably tert-amyl peroxypivalate is used as initiator.

Initiators, e.g. organic peroxides, are often mixed with solvents to make them easier to handle. Therefore, the initiator is preferably introduced in the form of a solution in one or more ketone(s) or hydrocarbons (especially olefins) which are liquid at room temperature. The initiator is preferably fed in as a 0.1 to 50% strength by weight solution, preferably a 0.5 to 20% strength by weight solution, in one or more hydrocarbons or one or more ketone(s) which are liquid at room temperature, mixtures of hydrocarbons (e.g. olefins or aromatic hydrocarbons such as toluene, ethylbenzene, ortho-xylene, meta-xylene and para-xylene, also cycloaliphatic hydrocarbons such as cyclohexane and aliphatic C₆-C₁₆-hydrocarbons, either branched or unbranched, for example n-heptane, n-octane, isooctane, n-decane, n-dodecane and in particular isododecane) or ketones (e.g. acetone, methyl isobutyl ketone, ethyl methyl ketone). In cases where the solvents for the initiator also function as chain transfer agents (for example ketones), the amount of said solvent is taken into account when calculating the amount of the chain transfer agent present in the monomer feed.

The amount of the initiator depends on the chemical nature of the initiator and can by adjusted by routine experiments. Typically, the initiator is present in 0.001 to 0.1 wt. %, preferably 0.01 to 0.05 wt. % based in each case on the total weight of the monomer feed.

The initiators employed herein can be introduced into the polymerization zone in any suitable manner, for example, by dissolving the initiator in a suitable solvent and injecting the initiator solution directly into the polymerization zone. Alternatively, the initiator may be injected into the ethylene feed stream or the feed stream containing compound C1 and optionally compound C2, prior to introduction thereof into the polymerization zone. However, the initiator is preferably not present in the monomer feed. The initiator can, for example, be fed in at the beginning, in the middle, after one third of the tube reactor or at a plurality of points on the tube reactor. In case of using an autoclave, the initiator can either be fed in at one point in the middle, in the upper part, in the bottom or at a plurality of points on the autoclave.

The polymerization process may be followed by post polymerization reactions, such as a hydrogenation. The hydrogenation may be a homogeneous or heterogenous catalytic hydrogenation. Usually, the hydrogenation is achieved with molecular hydrogen in the presence of a transition metal catalyst (e.g. based on Rh, Co, Ni, Pd, or Pt), which may be dissolved in solvents or supported on inorganic supports.

With particular preference, the ethylene copolymer EC does not comprise acid-functional groups and/or epoxide groups and/or polyoxyalkylene glycol groups. Thus, particularly preferred ethylene copolymers EC are free from the aforementioned groups, i.e. they comprise 0 wt. %, based on the total weight of the ethylene copolymer EC, of said groups.

The ethylene copolymer EC is usually not crystalline, so that in general no crystallization commencement temperature (T_{CC}) is measurable at T>15° C. with differential scanning calorimetry. Usually, a melt flow index cannot be determined for the ethylene copolymer EC.

The ethylene copolymer EC may have a pour point below 25° C., preferably below 20° C., and in particular below 15° C., as determined according to ASTM D 97-05.

Preferably, the ethylene copolymer EC has a hydroxyl number of more than 50 mg KOH/g solids. This large hydroxyl number allows to achieve a sufficient degree of carbamate functionalization and therefore crosslinking with the crosslinking agent CA, thus resulting in a high scratch resistance. Preferably, the ethylene copolymer has a hydroxyl number from 50 to 350 mg KOH/g solids, preferably from 80 to 300 mg KOH/g solids, very preferably 130 to 220 mg KOH/g solids, said hydroxyl number being calculated from the amount of hydroxy-group containing compound C1 present in the ethylene copolymer EC.

The ethylene copolymer EC preferably has a weight-average molecular weight M_{w} from 1,000 to 30,000 g/mol, more preferably from 1,500 to 15,000 g/mol, very preferably 4,000 to 9,000 g/mol, as determined by gel-permeation chromatography using polystyrene standards. The number-average molecular weight Mₙ of the ethylene copolymer EC is preferably in the range from 1,000 to 12,000 g/mol, preferably from 1,200 to 9,000 g/mol, more preferably from 1,500 to 7,000 g/mol, very preferably from 2,000 to 4,000 g/mol. The Mₙ can be determined as previously described in connection with the M_{w}.

The ethylene copolymer EC usually has a polydispersity PD (M_{w}/Mₙ) of 1.5 to 3.5, preferably from 1.7 to 3.0, and most preferably from 1.8 to 2.6.

The ethylene copolymer EC preferably has a glass transition temperature T_{g} of −100 to 10° C., preferably −80 to 0° C., very preferably −50 to −15° C., as determined by DSC on the second run using a temperature range of −90 to 180° C. at 15° C./min with a 60 minute isothermal hold at 180° C. after the first heat.

The ethylene copolymer EC may comprise—in polymerized form and based in each case on the total weight of the ethylene copolymer EC—from 20 to 70 wt. %, preferably from 25 to 65 wt. %, more preferably from 30 to 55 wt. %, of ethylene, as determined by ¹H-NMR.

The at least one polymerizable compound C1 comprising at least one hydroxyl group is preferably selected from hydroxyl group-containing (meth)acrylates, more preferably from hydroxy C₁-C₁₂ alkyl group-containing (meth)acrylates, even more preferably selected from 2-hydroxyethyl (meth)acrylate, 2-hydroxyisopropyl (meth)acrylate, 3-hydroxypropyl (meth)acrylate, hydroxyisobutyl (meth)acrylate and 4-hydroxybutyl (meth)acrylate, very preferably from 2-hydroxyethyl (meth)acrylate.

The ethylene copolymer EC may comprise—in polymerized form and based in each case on the total weight of the ethylene copolymer EC—from 1 to 70 wt. %, preferably from 10 to 60 wt. %, more preferably from 20 to 55 wt. %, very preferably 30 to 55 wt. %, of at least one polymerizable compound C1 comprising at least one hydroxyl group, preferably 2-hydroxyethyl (meth)acrylate, as determined by ¹H-NMR.

The at least one polymerizable compound C2 is preferably selected from alkyl (meth)acrylates, more preferably from C₁-C₂₂ alkyl (meth)acrylates, even more preferably from C₁-C₁₂ alkyl (meth)acrylates such as C₃ alkyl (meth)acrylates, C₄ alkyl (meth)acrylates, C₅ alkyl (meth)acrylates, C₆ alkyl (meth)acrylates, C₇ alkyl (meth)acrylates and C₈ alkyl (meth)acrylates, very preferably from methyl (meth)acrylate and/or n-butyl (meth)acrylate and/or 2-ethylhexyl (meth)acrylate.

The ethylene copolymer EC may comprise—in polymerized form and based in each case on the total weight of the ethylene copolymer EC—from 5 to 75 wt. %, preferably from 10 to 50 wt. %, more preferably from 10 to 35 wt. %, of at least one polymerizable compound C2, preferably methyl (meth)acrylate and/or n-butyl (meth)acrylate and/or 2-ethylhexyl (meth)acrylate, as determined by ¹H-NMR.

The following particularly preferred ethylene copolymers EC are used to prepare the carbamate-functional binder B contained in the inventive coating composition: Ethylene copolymer EC-1 comprising, preferably consisting of, —in polymerized form and based in each case on the total weight of the ethylene copolymer EC-1:
i. 10 to 80 wt. %, preferably 30 to 40 wt. %, of ethylene,
ii. 1 to 90 wt. %, preferably 40 to 50 wt. %, of at least one compound C1, in particular 2-hydroxyethyl (meth)acrylate, and
iii. 1 to 80 wt. %, preferably 15 to 25 wt. %, of at least one compound C2, in particular n-butyl (meth)acrylate.

Ethylene copolymer EC-2 comprising, preferably consisting of, —in polymerized form and based in each case on the total weight of the ethylene copolymer EC-2:
i. 10 to 80 wt. %, preferably 30 to 40 wt. %, of ethylene,
ii. 1 to 90 wt. %, preferably 30 to 40 wt. %, of at least one compound C1, in particular 2-hydroxyethyl (meth)acrylate, and
iii. 1 to 80 wt. %, preferably 25 to 35 wt. %, of at least one compound C2, in particular 2-ethylhexyl (meth)acrylate.

Ethylene copolymer EC-3 comprising, preferably consisting of, —in polymerized form and based in each case on the total weight of the ethylene copolymer EC-3:
i. 10 to 80 wt. %, preferably 35 to 45 wt. %, of ethylene,
ii. 1 to 90 wt. %, preferably 35 to 45 wt. %, of at least one compound C1, in particular 2-hydroxyethyl (meth)acrylate, and
iii. 1 to 80 wt. %, preferably 15 to 25 wt. %, of at least one compound C2, in particular methyl (meth)acrylate.

Ethylene copolymer EC-4 comprising, preferably consisting of, —in polymerized form and based in each case on the total weight of the ethylene copolymer EC-4:
i. 10 to 80 wt. %, preferably 45 to 55 wt. %, of ethylene,
ii. 20 to 90 wt. %, preferably 45 to 55 wt. %, of at least one compound C1, in particular 2-hydroxyethyl (meth)acrylate.

Ethylene copolymer EC-5 comprising, preferably consisting of, —in polymerized form and based in each case on the total weight of the ethylene copolymer EC-5:
i. 10 to 80 wt. %, preferably 35 to 45 wt. %, of ethylene,
ii. 1 to 90 wt. %, preferably 35 to 45 wt. %, of at least one compound C1, in particular 2-hydroxyethyl (meth)acrylate, and
iii. 2 to 90 wt. %, preferably 15 to 25 wt. %, of at least one compound C2, in particular a 1:1 (wt. %/wt. %) mixture of 2-ethylhexyl (meth)acrylate and methyl (meth)acrylate.

The carbamate functional compound reacted with the ethylene copolymer EC is preferably a carbamate compound of general formula (I)

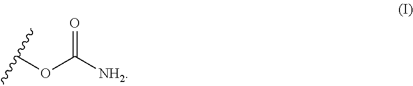

In this formula (I), the symbol

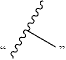

refers to a residue R linked to the oxygen atom via a single bond. R is preferably selected from (i) linear alkyl residues having 1 to 10 carbon atoms, such as methyl, ethyl, propyl, butyl, pentyl, hexyl, heptyl, octyl, nonyl and decyl; (ii) branched alkyl residues having 2 to 10 carbon atoms, such as isopropyl, isobutyl, tert-butyl and 2-ethylhexyl, (iii) cycloalkyl residues having 3 to 8 carbon atoms, such as cyclopropyl, cyclobutyl, cyclopentyl, cyclohexyl, cycloheptyl and cyclooctyl; (iv) aromatic residues such as phenyl; and (v) alkyl residues having 2 to 10 carbon atoms and further comprising at least one heteroatom selected from O or N, such as hydroxyethyl, hydroxypropyl, hydroxybutyl, hydroxypentyl, hydroxyhexyl, hydroxyheptyl, hydroxyoctyl, hydroxynonyl and hydroxydecyl.

With particular preference, the carbamate functional compound is an alkyl carbamate. Use of said alkyl carbamates for the functionalization of the ethylene copolymer EC results in a high degree of conversion of the hydroxy groups of the ethylene copolymer EC to carbamate groups.

In this respect, it is preferred if the alkyl carbamate is selected from the group of methyl carbamate, ethyl carbamate, n-propyl carbamate, isopropyl carbamate, n-butyl carbamate, isobutyl carbamate, tert-butyl carbamate, n-hexyl carbamate, 2-ethylhexyl carbamate, cyclohexyl carbamate, phenyl carbamate, and mixtures thereof, very preferably methyl carbamate.

The at least one carbamate compound, preferably methyl carbamate, is preferably reacted with the ethylene copolymer EC in a molar ratio of carbamate compound to hydroxyl groups present in the ethylene copolymer EC of 10:1 to 1:1, more preferably 5:1 to 1:1, very preferably 2:1 to 1:1. Use of a large excess of the carbamate compound ensures a high degree of conversion of the hydroxy groups of the ethylene copolymer EC to carbamate groups.

The transcarbamation is carried out in the presence of at least one catalyst. Said catalyst is preferably selected from tin containing catalysts, titanium (IV) alkoxides, zirconium (IV) acetylacetonate, bismuth-containing catalysts and mixtures thereof, preferably tin containing catalysts.

Preferred tin containing catalyst are selected from dialkyltin carboxylates, dialkyltin oxides and mixtures thereof, preferably dialkyltin oxides, very preferably dibutyltin oxide.

Preferred titanium (IV) alkoxide catalysts have n alkoxide groups, wherein n is an integer from one to four and each alkoxide group has 1 to 8 carbon atoms, and 4-n groups selected from halogen groups, acetylacetonate groups, and ethanolaminato groups, very preferably n is 4 and each alkoxide is selected from isopropoxide. A particularly preferred titanium (IV) alkoxide catalyst is therefore titanium (IV) isopropoxide.

Preferred bismuth-containing catalysts are selected from bismuth carboxylates further comprising at least one aromatic moiety. The at least one aromatic moiety is preferably located at the carboxylate residue. With particular preference, residues of the bismuth-containing catalysts are selected from 2,2′-diphenyl propionate and/or 2,2′-diphenyl decanoate.

The at least one catalyst, preferably dibutyltin oxide or zirconium (IV) acetylacetonate, may be used in a total amount of 0.01 to 2 wt. %, preferably 0.05 to 0.8 wt. %, more preferably 0.08 to 0.5 wt. %, very preferably 0.1 to 0.4 wt. %, based in each case on the total amount of the ethylene copolymer EC and the carbamate compound.

The transcarbamation is preferably carried out in the absence of oxygen, for example under a nitrogen atmosphere. The nitrogen blanket may be removed as the temperature begins to approach reflux as long as the nitrogen is resumed once reflex is lost. The reaction vessel is equipped with suitable stirring, heating and cooling equipment as well as with a reflux condenser which condenses volatile constituents, for example solvent and alcohol by-product formed during the transcarbamation reaction. A trap or some other device may also be included for removing the alcohol by-product.

The reaction between the at least one ethylene copolymer EC and the at least one carbamate compound in the presence of the at least one catalyst may be carried out at a temperature in the range of from about 120° C. to 140° C. An optimum temperature for the transcarbamation reaction may be determined by straightforward experimentation, and depends on factors, as should be expected, such as temperature, reactant concentrations, and solubility in the particular solvent system. As may be expected, a certain minimum temperature may need to be reached for the reaction to progress at a desired rate. Mineral acids such as phosphoric acid should be avoided.

The transcarbamation reactions is preferably carried out in an organic solvent or mixture of organic solvents that is inert toward the ethylene copolymer EC and the carbamate material used. Examples of suitable solvents include aromatic hydrocarbons, for example toluene, xylene, mesitylene, 2-, 3-, or 4-ethyltoluene, naphthas, aliphatic and cycloaliphatic hydrocarbons, for example cyclohexanone, various white spirits, mineral turpentine, tetralin and decalin, and also ketones, individually or as mixtures, preferably toluene and/or cyclohexanone and/or aromatic hydrocarbons.

Preferably, the transcarbamation reaction is carried out in an organic solvent mixture comprising toluene and cyclohexanone or toluene and aromatic hydrocarbons or cyclohexanone and aromatic hydrocarbons, wherein said solvent mixture contains at least 50 wt. %, preferably 50 to 60 wt. %, of cyclohexanone or aromatic hydrocarbons, based on the total weight of the solvent mixture.

The progress of the transcarbamation reaction may be carried out by monitoring the hydroxyl number of the ethylene copolymer EC or by monitoring the amount of by-product alcohol (e.g., methanol for methyl carbamate) collected. It is possible to perform further thermal steps, for example vacuum stripping, to remove organic volatiles from the carbamate-functional binder B. The transcarbamation reaction may provide a conversion of at least about 70% of theoretical total replacement of hydroxyl groups with carbamate groups when by-product alcohol (e.g., methanol for methyl carbamate) is removed as it forms, depending upon the temperature of the reaction, the time of the reaction, and the concentrations of the hydroxyl groups, carbamate compound, and the catalyst.

The coating composition may comprise the at least one binder B containing at least one carbamate group in a total amount of 0.1 to 50 wt. % solids, preferably 1 to 40 wt. % solids, more preferably 5 to 35 wt. % solids, very preferably 12 to 30 wt. % solids, based in each case on the total weight of the coating composition. Use of said amounts of carbamate-functional binder B in combination with at least one crosslinking agent CA described later on result in sufficient crosslinking of the coating composition, thus allowing to achieve satisfactory stone chipping and acid resistance.

Crosslinking Agent CA:

The second mandatory component of the inventive coating composition is a crosslinking agent CA. Crosslinking agents comprises at least one reactive functional group which is able to undergo crosslinking reactions with the carbamate group(s) present in the at least one binder B. Moreover, further crosslinking agents might be present which are able to undergo crosslinking reactions with hydroxyl groups optionally present in the at least one binder B as well as functional groups present in the further binder B1 being different from binder B and described later on. Since the at least one binder B contains reactive functional groups in the form of carbamate groups, preferred reactive functional groups which are able to undergo crosslinking reactions with such carbamate groups are melamine-functional groups. Moreover, the at least one binder B contains a small amount of unreacted hydroxyl groups which can be crosslinked with isocyanate groups. Preferred combinations of functional groups, accordingly, are selected from
carbamate-functional groups in the binder B and melamine-functional groups in the crosslinking agent CA,
hydroxy-functional groups in the binder B and isocyanate groups in the crosslinking agent CA.

As crosslinking agent (CA), the coating compositions of the invention preferably comprise isocyanate crosslinking agents and other crosslinkers, such as amino resin curing agents and trisalkoxycarbonylaminotriazines (TACT), for example, alone or in combination with one another.

The coating compositions of the invention preferably comprise compound (CA) having free and/or blocked isocyanate groups, optionally together with further crosslinking agents, more particularly with amino resins and/or tris(alkoxycarbonylamino)triazines. When the isocyanate crosslinking agent (CA) is used in 1K (one-component) coating materials, the isocyanates are reacted, in a manner known to the skilled worker, with a blocking agent, the selection of the blocking agent being guided in particular by the desired curing temperature, as the skilled worker is aware.

Examples of preferred compounds (CA) are inherently known substituted or unsubstituted aromatic, aliphatic, cycloaliphatic and/or heterocyclic polyisocyanates, preference being given to the use of aliphatic and/or cycloaliphatic polyisocyanates. Examples of preferred aliphatic and/or cycloaliphatic polyisocyanates are as follows: tetramethylene 1,4-diisocyanate, hexamethylene 1,6-diisocyanate, 2,2,4-trimethylhexane 1,6-diisocyanate, isophorone diisocyanate, ethylene diisocyanate, 1,12-dodecane diisocyanate, cyclobutane 1,3-diisocyanate, cyclohexane 1,3-diisocyanate, cyclohexane 1,4-diisocyanate, methylcyclohexyl diisocyanates, hexahydrotoluene 2,4-diisocyanate, hexahydrotoluene 2,6-diisocyanate, hexahydrophenylene 1,3-diisocyanate, hexahydrophenylene 1,4-diisocyanate, perhydrodiphenylmethane 2,4′-diisocyanate, 4,4′-methylenedicyclohexyl diisocyanate (e.g., Desmodur® W from Bayer AG), tetramethylxylyl diisocyanates (e.g., TMXDI® from American Cyanamid), and mixtures of the aforementioned polyisocyanates.

Additionally preferred compounds (CA) are the dimers and trimers, more particularly the biuret dimers and the isocyanurate trimers, of the aforementioned diisocyanates.

Particularly preferred compounds (CA) are hexamethylene 1,6-diisocyanate, isophorone diisocyanate, and 4,4′-methylenedicyclohexyl diisocyanate, their biuret dimers and/or isocyanurate trimers.

The aforelisted crosslinking agents (CA) are well known to the skilled worker and are offered as commercial products by numerous companies.

The at least one crosslinking agent CA may be present in a total amount of 1 to 30 wt. % solids, preferably 3 to 25 wt. % solids, more preferably 4 to 20 wt. % solids, very preferably 5 to 15 wt. % solids, based in each case on the total weight of the coating composition. These amounts ensure a sufficient degree of crosslinking while simultaneously allowing to optimize the coating composition with respect to solids content and compatibility of the ingredients of the coating composition.

Further Components of the Inventive Coating Composition:

The coating composition of the invention may further comprise at least one crosslinking catalyst CAT to facilitate the crosslinking reaction between the carbamate-functional binder B, optionally present further binders B1 and the at least one crosslinking agent (CA) previously discussed.

Suitable crosslinking catalysts CAT are selected from tin containing catalysts, bismuth containing catalysts, zirconium containing catalysts, lithium containing catalysts and mixtures thereof, preferably dibutyltin dicacetate, bismuth carboxylates, zirconium carboxylates, lithium carboxylates and mixtures thereof.

Suitable amounts of crosslinking catalyst CAT, preferably dibutyltin diacetate, bismuth carboxylates, zirconium carboxylates, lithium carboxylates and mixtures thereof, are 0.005 to 1 wt. %, preferably 0.08 to 0.2 wt. %, based in each case on the total weight of the coating composition.

The coating composition of the invention may further comprise at least one binder B1, said binder B1 being different from binder B. Suitable binders B1 are selected from (i) carbamate-functional materials, preferably carbamate-functional acrylic polymers, carbamate-functional polycarbonates, carbamate-functional polyesters and mixtures thereof; (ii) hydroxy-functional materials, preferably hydroxy-functional poly (meth)acrylates, hydroxy-functional polyurethanes, hydroxy-functional polyurethane (meth)acrylate hybrid polymers, hydroxy-functional polyesters, hydroxy-functional polyethers and mixtures thereof; (iii) carboxylic acid-functional materials; (iv) epoxy-functional materials; and (v) mixtures of the aforelisted materials, preferably carbamate-functional acrylic polymers, carbamate-functional polycarbonates, carbamate-functional polyesters, hydroxy-functional poly(meth)acrylates and mixtures thereof.

The at least one further binder B1 may be present in a total amount of 0.1 to 50 wt. % solids, preferably 5 to 45 wt. % solids, more preferably 10 to 40 wt. % solids, very preferably 25 to 35 wt. % solids, based in each case on the total weight of the coating composition.

If the inventive coating compositions comprise at least one carbamate-functional material as further binder B1, the at least one carbamate-functional ethylene copolymer B is preferably present in a total amount of at least 30 mol %, very preferably from 30 to 100 mol %, based on the total carbamate equivalent of all carbamate-functional materials present in the coating composition.

The coating composition of the invention may further comprise at least one additive selected from the group consisting of (i) UV absorbers; (ii) light stabilizers such as HALS compounds, benzotriazoles or oxalanilides; (iii) rheology modifiers such as sagging control agents (urea crystal modified resins), organic thickeners and inorganic thickeners; (iv) free-radical scavengers; (v) slip additives; (vi) polymerization inhibitors; (vii) defoamers; (viii) wetting agents; (ix) fluorine compounds; (x) adhesion promoters; (xi) leveling agents; (xii) film-forming auxiliaries such as cellulose derivatives; (xiii) fillers, such as nanoparticles based on silica, alumina or zirconium oxide; (xiv) flame retardants; and (xv) mixtures thereof. Specific examples of the described additives are well known to the person skilled in the art and are selected depending on the specific properties to be achieved with the inventive coating composition. These additives may be used in customary amounts, for example in amounts of 0.1 to up to 20 wt. %, based on the total weight of the coating composition.

Depending on the particular crosslinking agent CA present in the coating composition, said composition is configured as a one-component system (1K) or is obtainable by mixing two (two-component system, 2K) or more (multicomponent system) components. In thermochemically curable one-component systems (1K), the components to be crosslinked, in other words binder and crosslinking agent, are present alongside one another, in other words in one component. A condition for this is that the components to be crosslinked react with one another effectively only at relatively high temperatures, of more than 100° C., for example, so as to prevent premature thermochemical curing during storage. Such a combination may be exemplified by hydroxy- or carbamate-functional polymer with melamine resins and/or blocked polyisocyanates as crosslinking agents.

In thermochemically curable two-component or multicomponent systems, the components to be crosslinked, in other words binders and the crosslinking agents, are present separately from one another in at least two components, which are combined shortly before the application. This form is selected when the components to be crosslinked react with one another effectively even at ambient temperatures or slightly elevated temperatures of, for example, 40 to 90° C. Such a combination may be exemplified by hydroxy- or carbamate-functional binders with free polyisocyanates as crosslinking agents. Particularly preferred compositions are two-component compositions which have to be mixed prior to application onto the substrate and which preferably comprise the binder B and the crosslinking agent CA in separate containers. In case the composition is obtainable by mixing two or more components, the weight ratio of the binder-containing component to the crosslinker-containing component is preferably from 85:15 to 15:85. Mixing may take place manually, with the appropriate amount of a first component being introduced into a vessel, admixed with the corresponding quantity of the second component. However, mixing of the two or more components can also be performed automatically by means of an automatic mixing system. Such an automatic mixing system can comprise a mixing unit, more particularly a static mixer, and also at least two devices for supplying the binder containing first component and the crosslinker containing second component, more particularly gear pumps and/or pressure valves.

The coating composition of the invention is preferably a clearcoat composition or a tinted clearcoat composition. Clearcoat compositions do usually not comprise any coloring and/or effect pigments, i.e. the amount of coloring and/or effect pigments is preferably 0 wt. %, based on the total weight of the coating composition. However, these clearcoat materials can contain filler materials and matting agents to adjust the gloss.

Tinted clearcoat composition are, when applied to a substrate, neither completely transparent and colorless as a clear coating nor completely opaque as a typical pigmented coating. A tinted clear coating is therefore transparent and colored or semi-transparent and colored. The color can be achieved by adding at least one pigment and/or dye commonly used in coating compositions. Suitable pigments are, for example, organic and inorganic coloring pigments, effect pigments and mixtures thereof. Such color pigments and effect pigments are known to those skilled in the art and are described, for example, in Römpp-Lexikon Lacke und Druckfarben, Georg Thieme Verlag, Stuttgart, New York, 1998, pages 176 and 451. The terms “coloring pigment” and “color pigment” are interchangeable, just like the terms “visual effect pigment” and “effect pigment”. Suitable inorganic coloring pigments are selected from (i) white pigments, such as titanium dioxide, zinc white, colored zinc oxide, zinc sulfide, lithopone; (ii) black pigments, such as iron oxide black, iron manganese black, spinel black, carbon black; (iii) color pigments, such as ultramarine green, ultramarine blue, manganese blue, ultramarine violet, manganese violet, iron oxide red, molybdate red, ultramarine red, iron oxide brown, mixed brown, spinel and corundum phases, iron oxide yellow, bismuth vanadate; (iv) filer pigments, such as silicon dioxide, quartz flour, aluminum oxide, aluminum hydroxide, natural mica, natural and precipitated chalk, barium sulphate and (vi) mixtures thereof.

Suitable organic coloring pigments are selected from (i) monoazo pigments such as C.I. Pigment Brown 25, C.I. Pigment Orange 5, 36 and 67, C.I. Pigment Orange 5, 36 and 67, C.I. Pigment Red 3, 48:2, 48:3, 48:4, 52:2, 63, 112 and 170 and C.I. Pigment Yellow 3, 74, 151 and 183; (ii) diazo pigments such as C.I. Pigment Red 144, 166, 214 and 242, C.I. Pigment Red 144, 166, 214 and 242 and C.I. Pigment Yellow 83; (iii) anthraquinone pigments such as C.I. Pigment Yellow 147 and 177 and C.I. Pigment Violet 31; (iv) benzimidazole pigments such as C.I. Pigment Orange 64; (v) quinacridone pigments such as C.I. Pigment Orange 48 and 49, C.I. Pigment Red 122, 202 and 206 and C.I. Pigment Violet 19; (vi) quinophthalone pigments such as C.I. Pigment Yellow 138; (vii) diketopyrrolopyrrole pigments such as C.I. Pigment Orange 71 and 73 and C.I. Pigment Red, 254, 255, 264 and 270; (viii) dioxazine pigments such as C.I. Pigment Violet 23 and 37; (ix) indanthrone pigments such as C.I. Pigment Blue 60; (x) isoindoline pigments such as C.I. Pigment Yellow 139 and 185; (xi) isoindolinone pigments such as C.I. Pigment Orange 61 and C.I. Pigment Yellow 109 and 110; (xii) metal complex pigments such as C.I. Pigment Yellow 153; (xiii) perinone pigments such as C.I. Pigment Orange 43; (xiv) perylene pigments such as C.I. Pigment Black 32, C.I. Pigment Red 149, 178 and 179 and C.I. Pigment Violet 29; (xv) phthalocyanine pigments such as C.I. Pigment Violet 29, C.I. Pigment Blue 15, 15:1, 15:2, 15:3, 15:4, 15:6 and 16 and C.I. Pigment Green 7 and 36; (xvi) aniline black such as C.I. Pigment Black 1; (xvii) azomethine pigments; and (xviii) mixtures thereof.

Suitable effect pigments are selected from the group consisting of (i) plate-like metallic effect pigments such as plate-like aluminum pigments, gold bronzes, fire-colored bronzes, iron oxide-aluminum pigments; (ii) pearlescent pigments, such as metal oxide mica pigments; (iii) plate-like graphite pigments; (iv) plate-like iron oxide pigments; (v) multi-layer effect pigments from PVD films; (vi) liquid crystal polymer pigments; and (vii) mixtures thereof.

The tinted clear coating compositions preferably comprise the at least one color and/or effect pigment in a total amount of 0.1 to 10 wt. %, preferably 1 to 4 wt. %, based on the total weight of the coating composition.

The coating composition according to the invention is preferably a solvent-based composition in which organic solvents are included as a principal constituent, i.e. in amounts of more than 20 wt. %, more preferably at least 30 wt. %, based on the total weight of the coating composition. Organic solvents constitute volatile components of the composition and undergo complete or partial vaporization on drying or flashing, respectively. Suitable organic solvents are, for example, ketones such as acetone, methyl ethyl ketone, cyclohexanone, methyl isobutyl ketone, methyl isoamyl ketone or diisobutyl ketone; esters such as ethyl acetate, n-butyl acetate, ethylene glycol diacetate, butyrolactone, diethyl carbonate, propylene carbonate, ethylene carbonate, 2-methoxypropyl acetate (MPA), and ethyl ethoxypropionate; amides such as N,N-dimethylformamide, N,N-dimethylacetamide, N-methylpyrrolidone, and N-ethylpyrrolidone; methylal, butylal, 1,3-dioxolane, glycerol formal. Especially preferred organic solvents are n-butyl acetate and 1-methoxypropyl acetate.

Such solvent-based compositions preferably comprise water in a total amount of 0 to 20 wt. %, preferably 0 to 10 wt. %, more preferably 0 to 5 wt. %, and very preferably 1 to 5 wt. %, based in each case on the total weight of the coating composition. In turn, the at least one organic solvent is preferably present in a total amount of 10 to 70 wt. %, preferably 20 to 60 wt. %, very preferably 40 to 50 wt. %, based in each case on the total weight of the coating composition.

The coating composition of the invention may have a solids content of 30 to 80 wt. %, very preferably 50 to 60 wt. %, based in each case on the total weight of the coating composition.

Inventive Method:

The present invention is also directed to a method of coating a substrate with the inventive coating compositions in which the inventive coating compositions are applied on the substrate optionally coated with a basecoat film or layer, a coating film is formed form the inventive coating composition and said coating film is afterwards cured.

The substrate is preferably selected from metallic substrates, metallic substrates coated with a cured electrocoat and/or a cured filler, plastic substrates and substrates comprising metallic and plastic components, especially preferably from metallic substrates. In case of metallic and plastic substrates or substrates comprising metallic and plastic components, said substrates may be pretreated before optional step (1) or step (2) of the inventive process in any conventional way—that is, for example, cleaned (for example mechanically and/or chemically) and/or provided with known conversion coatings (for example by phosphating and/or chromating) or surface activating pre-treatments (for example by flame treatment, plasma treatment and corona discharge coming).

In this respect, preferred metallic substrates are selected from iron, aluminum, copper, zinc, magnesium and alloys thereof as well as steel. Preferred substrates are those of iron and steel, examples being typical iron and steel substrates as used in the automobile industry sector. The substrates themselves may be of whatever shape—that is, they may be, for example, simple metal panels or else complex components such as, in particular, automobile bodies and parts thereof.

As substrates it is also possible, moreover, to use those which contain both metallic and plastics fractions. Substrates of this kind are, for example, vehicle bodies containing plastics parts.

Metallic substrates comprising a cured electrocoating can be obtained by electrophoretically applying an electrocoat material on the metallic substrate and curing said applied material at a temperature of 100 to 250° C., preferably 140 to 220° C. for a period of 5 to 60 minutes, preferably 10 to 45 minutes. Before curing, said material can be flashed off, for example, at 15 to 35° C. for a period of, for example, 0.5 to 30 minutes and/or intermediately dried at a temperature of preferably 40 to 90° C. for a period of, for example, 1 to 60 minutes. Suitable electrocoat materials and also their curing are described in WO 2017/088988 A1, and comprise hydroxy-functional polyether amines as binder and blocked polyisocyanates as crosslinking agent. Before application of the electrocoating material, a conversion coating, such as a zinc phosphate coat, can be applied to the metallic substrate. The film thickness of the cured electrocoat is, for example, 10 to 40 micrometers, preferably 15 to 25 micrometers.

Metallic substrates comprising a cured electrocoating and/or a cured filler can be obtained by applying a filler composition to a metallic substrate (S) optionally comprising a cured electrocoating or to a metallic and/or plastic substrate (S) and curing said filler composition at a temperature of 40 to 100° C., preferably 60 to 80° C. for a period of 5 to 60 minutes, preferably 3 to 8 minutes. Suitable filler compositions are well known to the person skilled in the art and are, for example, commercially available under the brand name Glasurit from BASF Coatings GmbH. The film thickness of the cured filler is, for example, 30 to 100 micrometers, preferably 50 to 70 micrometers.

Optional Step (1):

In optional step (1) of the inventive method, at least one pigmented basecoat composition is applied on the substrate, a film is formed from said composition and said film is optionally cured. Preferably, the applied basecoat composition is only briefly dried before the inventive coating composition is afterwards applied in step (2). Joint curing of the basecoat film and the film formed from the inventive coating composition is then performed in optional step (4) of the inventive method. The application of a coating composition to the substrate is understood as follows: the coating composition in question is applied such that the coating film produced from said composition is disposed on the substrate, but need not necessarily be in direct contact with the substrate. For example, between the coating film and the substrate, there may be other coats disposed. Preferably, the coating composition is applied directly to the substrate in step (1), meaning that the coating film produced is in direct contact with the substrate.

The pigmented basecoat compositions may be applied by the methods known to the skilled person for applying liquid coating materials, as for example by dipping, knifecoating, spraying, rolling, or the like. Preference is given to employing spray application methods, such as, for example, compressed air spraying (pneumatic application), airless spraying, high-speed rotation, electrostatic spray application (ESTA), optionally in conjunction with hot spray application such as hot air (hot spraying), for example. With very particular preference the pigmented basecoat composition is applied via pneumatic spray application or electrostatic spray application. The pigmented basecoat composition is applied such that the basecoat layer preferably has a film thickness of 5 to 35 μm, preferably 10 to 30 μm.

After application, the basecoat composition can be flashed off and/or dried in order to form a basecoat film on the substrate. “Flashing” or “flash off” is understood as passive or active evaporation of solvents from the pigmented basecoat composition, preferably at 15 to 35° C. for a duration of 0.5 to 30 minutes. In contrast, drying is understood as passive or active evaporation of solvents at a higher temperature than used for flashing, for example at 40 to 90° C. for a duration of 1 to 60 minutes. However, neither flash off nor drying does result in a cured coating layer.

Curing of the basecoat film formed after flash off and/or drying is preferably performed at temperatures of 50 to 200° C., preferably 120 to 160° C., for a duration of 20 to 40 minutes. The curing of a coating film or composition is understood accordingly to be the conversion of such a film or composition into the service-ready state, in other words into a state in which the substrate furnished with the coating film in question can be transported, stored, and used in its intended manner. A cured coating film, then, is in particular no longer soft, but instead is conditioned as a solid coating film which, even on further exposure to curing conditions as described later on below, no longer exhibits any substantial change in its properties such as hardness or adhesion to the substrate.

However, it is preferred within the present invention if the basecoat film is not cured separately but jointly with the subsequently applied coating composition of the invention.

Suitable basecoat compositions are all aqueous and solvent-borne pigmented basecoat compositions known to the person skilled in the art. Preferably, aqueous pigmented basecoat compositions are used.

It is possible in step (1) to apply more than one basecoat film or basecoat layer by repeating step (1). The basecoat compositions used if step (1) is repeated can be the same or can differ from each other. For example, the first basecoat composition can contain only color pigments while the second basecoat composition can contain only effect pigments.

Step (2):

In step (2) of the inventive method, an inventive coating composition is applied to the basecoat film or cured basecoat layer formed in optional step (1) or to the substrate. The inventive coating compositions may be applied by the methods known to the skilled person for applying liquid coating materials, as for example by dipping, knifecoating, spraying, rolling, or the like. With very particular preference the coating composition is applied via pneumatic spray application or electrostatic spray application.

Step (3):

In step (3) of the inventive method, a coating film is formed from the coating composition applied in step (2). The formation of a film from the applied coating composition can be affected, for example, by flashing off and/or drying the applied coating composition as previously described in connection with optional step (1).

The formation of the coating film in step (3) is performed at a temperature of 20 to 60° C. for a duration of 5 to 40 minutes, preferably performed at a temperature of 20 to 35° C. for a duration of 5 minutes to 15 minutes.

Step (4):

In step (4) of the inventive method, the coating film produced in step (1) and/or (3) is cured. In case optional step (1) is performed and the basecoat film resulting from step (1) has not yet been cured, curing of said at least basecoat layer is done together with the curing of the coating film formed in step (3).

In principle the curing is carried out at temperatures of 40 to 200° C., for example, in particular 120 to 160° C., for a duration of 5 to 80 minutes, preferably 20 to 40 minutes.

Typically layer thicknesses obtained after step (4) range from 15 μm to 80 μm, preferably 20 μm to 70 μm or 30 μm to 65 μm such as 40 μm to 60 μm.

The coating layers produced from the inventive coating compositions have an improved resistance towards scratches compared to coating layers produced from carbamate-functional acrylic resins. However, the optical properties are not negatively influenced, i.e. the coating layers produced by the inventive coating compositions have a high gloss, are non-yellowing and can be produced in thick layers of more than 40 μm without cracking.

What has been said about the inventive coating composition applies mutatis mutandis with respect to further preferred embodiments of the inventive method.

Coated Substrate:

The result obtained after step (4) of the inventive method is a coated substrate containing at least a pigmented basecoat layer and a clearcoat layer formed from the inventive coating composition.

The inventive coating compositions result in an improved scratch resistance as well as improved stone chip resistance of the cured coating layers as compared to coating layers being obtained from coating compositions comprising carbamate-functional acrylate binders.

What has been said about the inventive coating composition applies mutatis mutandis with respect to further preferred embodiments of the inventive coated substrate.

Inventive Use:

Finally, the present invention relates to the use of the inventive coating composition for improving the scratch resistance of coating layers, especially of clearcoat layers, wherein said improvement is obtained with respect to a coating composition not containing a binder B comprising the carbamate-functional ethylene copolymer.

What has been said about the inventive coating composition and the inventive method applies mutatis mutandis with respect to further preferred embodiments of the inventive use.

The invention is described in particular by the following embodiments:

Coating composition comprising:
a) at least one binder B containing at least one carbamate group, said binder B being prepared by reacting at least one ethylene copolymer EC with at least one carbamate compound in the presence of at least one catalyst, said ethylene copolymer EC comprising—in polymerized form—
   i. 10 to 80 wt. % of ethylene;
   ii. 1 to 90 wt. % of at least one polymerizable compound C1 having at least one hydroxyl group; and
   iii. 0 to 80 wt. % of at least one further polymerizable compound C2 being different from compound C1; and
b) at least one crosslinking agent CA.

Embodiment 2: coating composition according to embodiment 1, wherein the ethylene copolymer EC is prepared in a continuous high-pressure polymerization process.

Embodiment 3: coating composition according to embodiment 2, wherein the polymerization process is carried out at a pressure in the range from 1,000 to 4,000 bar, preferably from 1,200 to 2,500 bar, very preferably 1,500 to 2,200 bar.

Embodiment 4: coating composition according to embodiments 2 or 3, wherein the reaction temperature is in the range of 150 to 300° C., preferably 170 to 250° C., and in particular 190 to 230° C.

Embodiment 5: coating composition according to any of embodiments 2 to 4, wherein the polymerization process is carried out using a monomer feed comprising ethylene, the at least one polymerizable compound C1 and optionally the at least polymerizable compound C2.

Embodiment 6: coating composition according to embodiment 5, wherein the monomer feed comprises ethylene in a total amount of 30 to 98 wt. %, preferably 40 to 95 wt. %, and in particular 50 to 70 wt. % or from 70 to 85 wt. %, based on the total weight of the monomer feed.

Embodiment 7: coating composition according to embodiment 5 or 6, wherein the monomer feed comprises the at least one polymerizable compound C1 comprising at least one hydroxy group in a total amount of 10 to 70 wt. %, preferably 20 to 60 wt. %, and in particular 36 to 55 wt. %, based in each case on the total weight of the monomer feed.

Embodiment 8: coating composition according to any of embodiments 5 to 7, wherein the monomer feed comprises the at least one polymerizable. compound C2 in a total amount of 5 to 70 wt. %, preferably 10 to 60 wt. %, and in particular 15 to 55 wt. %, based in each case on the total weight of the monomer feed.

Embodiment 9: coating composition according to any of embodiments 2 to 8, wherein the polymerization process is carried out in the presence of at least one chain transfer agent, said chain transfer agent being preferably selected from saturated or unsaturated hydrocarbons, aliphatic ketones, aliphatic aldehydes, hydrogen, or mixtures thereof, more preferably aliphatic aldehydes and/or aliphatic ketones and/or hydrogen, very preferably propionaldehyde and/or methyl ethyl ketone and/or hydrogen.

Embodiment 10: coating composition according to embodiment 9, wherein the chain transfer agent is a mixture of propionaldehyde and methyl ethyl ketone in a weight ratio of 4:1 to 1:4, preferably from 3.5:1 to 1:3.0, in particular from 2.8:1 to 1:2.5.

Embodiment 11: coating composition according to embodiment 9 or 10, wherein the at least one chain transfer agent is present in a total amount of least 2 wt. %, preferably 4 to 28 wt. %, more preferably 6 to 23 wt. %, very preferably 9 to 13 wt. % or 13 to 20 wt. %, based on the total weight of the monomer feed.

Embodiment 12: coating composition according to any of embodiments 2 to 11, wherein the polymerization process is carried out in the presence of at least one initiator, said initiator being preferably selected from di-tert-butyl peroxide, tert-amyl peroxypivalate, tert-butyl peroxypivalate, tert-butyl peroxyisononanoate, tert-butyl peroxy-2-ethylhexanoate, 2,2-di(tert-butylperoxy)butane and mixtures thereof, very preferably from tert-amyl peroxypivalate.

Embodiment 13: coating composition according to embodiment 12, wherein the initiator is present in a total amount of 0.0.001 to 0.1 wt. %, preferably 0.01 to 0.05 wt. % based in each case on the total weight of the monomer feed.

Embodiment 14: coating composition according to any of embodiments 2 to 13, wherein the polymerization process is followed by a hydrogenation.

Embodiment 15: coating composition according to any of the preceding embodiments, wherein the ethylene copolymer EC does not comprise acid-functional groups and/or epoxide groups and/or polyoxyalkylene glycol groups.

Embodiment 16: coating composition according to any of the preceding embodiments, wherein the ethylene copolymer EC consists of compounds i., ii. and optionally iii.

Embodiment 17: coating composition according to any of the preceding embodiments, wherein the ethylene copolymer EC has a pour point below 25° C., preferably below 20° C., and in particular below 15° C., as determined according to ASTM D 97-05.

Embodiment 18: coating composition according to any of the preceding embodiments, wherein the ethylene copolymer EC has a hydroxyl number from 50 to 350 mg KOH/g solids, preferably from 80 to 300 mg KOH/g solids, very preferably 130 to 220 mg KOH/g solids, said hydroxyl number being calculated from the amount of hydroxy-group containing compound C1 present in the ethylene copolymer EC.

Embodiment 19: coating composition according to any of the preceding embodiments, wherein the ethylene copolymer EC has a weight-average molecular weight M_{w} from 1,000 to 30,000 g/mol, preferably from 1,500 to 15,000 g/mol, very preferably 4,000 to 9,000 g/mol, as determined by gel-permeation chromatography using polystyrene standards.

Embodiment 20: coating composition according to any of the preceding embodiments, wherein the ethylene copolymer EC has a polydispersity PD (M_{w}/Mₙ) of 1.5 to 3.5, preferably 1.7 to 3.0, very preferably 1.8 to 2.6.

Embodiment 21: coating composition according to any of the preceding embodiments, wherein the ethylene copolymer EC has a glass transition temperature T_{g} of −100 to 10° C., preferably −80 to 0° C., very preferably −50 to −15° C., as determined by DSC on the second run using a temperature range of −90 to 180° C. at 15° C./min with a 60 minute isothermal hold at 180° C. after the first heat.

Embodiment 22: coating composition according to any of the preceding embodiments, wherein the ethylene copolymer EC comprises—in polymerized form and based in each case on the total weight of the ethylene copolymer—from 20 to 70 wt. %, preferably from 25 to 65 wt. %, more preferably from 30 to 55 wt. %, of ethylene, as determined by ¹H-NMR.

Embodiment 23: coating composition according to any of the preceding embodiments, wherein the at least one polymerizable compound C1 comprising at least one hydroxyl group is selected from hydroxyl group-containing (meth)acrylates, preferably hydroxy C₁-C₁₂ alkyl group-containing (meth)acrylates, more preferably selected from 2-hydroxyethyl (meth)acrylate, 2-hydroxyisopropyl (meth)acrylate, 3-hydroxypropyl (meth)acrylate, hydroxyisobutyl (meth)acrylate and 4-hydroxybutyl (meth)acrylate, very preferably 2-hydroxyethyl (meth)acrylate.

Embodiment 24: coating composition according to any of the preceding embodiments, wherein the ethylene copolymer EC comprises—in polymerized form and based in each case on the total weight of the ethylene copolymer EC—from 1 to 70 wt. %, preferably from 10 to 60 wt. %, more preferably from 20 to 55 wt. %, very preferably 30 to 55 wt. %, of at least one polymerizable compound C1 comprising at least one hydroxyl group, preferably 2-hydroxyethyl (meth)acrylate, as determined by ¹H-NMR.

Embodiment 25: coating composition according to any of the preceding embodiments, wherein the at least one polymerizable compound C2 is selected from alkyl (meth)acrylates, preferably C₁-C₂₂ alkyl (meth)acrylates, more preferably C₁-C₁₂ alkyl (meth)acrylates, very preferably methyl (meth)acrylate and/or n-butyl (meth)acrylate and/or 2-ethylhexyl (meth)acrylate.

Embodiment 26: coating composition according to any of the preceding embodiments, wherein the ethylene copolymer EC comprises—in polymerized form and based in each case on the total weight of the ethylene copolymer EC—from 5 to 75 wt. %, preferably from 10 to 50 wt. %, more preferably from 10 to 35 wt. %, of at least one polymerizable compound C2, preferably methyl (meth)acrylate and/or n-butyl (meth)acrylate and/or 2-ethylhexyl (meth)acrylate, as determined by ¹H-NMR.

Embodiment 27: coating composition according to any of the preceding embodiments, wherein the ethylene copolymer EC comprises in polymerized form and based in each case on the total weight of the ethylene copolymer EC—10 to 80 wt. %, preferably 30 to 40 wt. %, of ethylene, 1 to 90 wt. %, preferably 40 to 50 wt. %, of at least one compound C1, in particular 2-hydroxyethyl (meth)acrylate and 1 to 80 wt. %, preferably 15 to 25 wt. %, of at least one compound C2, in particular n-butyl (meth)acrylate.

Embodiment 28: coating composition according to any of embodiments 1 to 26, wherein the ethylene copolymer EC comprises in polymerized form and based in each case on the total weight of the ethylene copolymer EC—10 to 80 wt. %, preferably 30 to 40 wt. %, of ethylene, 1 to 90 wt. %, preferably 30 to 40 wt. %, of at least one compound C1, in particular 2-hydroxyethyl (meth)acrylate and 1 to 80 wt. %, preferably 25 to 35 wt. %, of at least one compound C2, in particular 2-ethylhexyl (meth)acrylate.

Embodiment 29: coating composition according to any of embodiments 1 to 26, wherein the ethylene copolymer EC comprises in polymerized form and based in each case on the total weight of the ethylene copolymer EC—10 to 80 wt. %, preferably 35 to 45 wt. %, of ethylene, 1 to 90 wt. %, preferably 35 to 45 wt. %, of at least one compound C1, in particular 2-hydroxyethyl (meth)acrylate and 1 to 80 wt. %, preferably 15 to 25 wt. %, of at least one compound C2, in particular methyl (meth)acrylate.

Embodiment 30: coating composition according to any of embodiments 1 to 26, wherein the ethylene copolymer EC comprises in polymerized form and based in each case on the total weight of the ethylene copolymer EC—10 to 80 wt. %, preferably 45 to 55 wt. %, of ethylene and 20 to 90 wt. %, preferably 45 to 55 wt. %, of at least one compound C1, in particular 2-hydroxyethyl (meth)acrylate.

Embodiment 31: coating composition according to any of embodiments 1 to 26, wherein the ethylene copolymer EC comprises in polymerized form and based in each case on the total weight of the ethylene copolymer EC—10 to 80 wt. %, preferably 35 to 45 wt. %, of ethylene, 1 to 90 wt. %, preferably 35 to 45 wt. %, of at least one compound C1, in particular 2-hydroxyethyl (meth)acrylate, 2 to 90 wt. %, preferably 15 to 25 wt. % of at least one compound C2, in particular 2-ethylhexyl (meth)acrylate and methyl (meth)acrylate.

Embodiment 32: coating composition according to any of the preceding embodiments, wherein the carbamate functional compound is a carbamate compound of general formula (I)

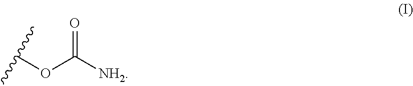

Embodiment 33: coating composition according to any of the preceding embodiments, wherein the carbamate functional compound is an alkyl carbamate.

Embodiment 34: coating composition according embodiment 33, wherein the alkyl carbamate is selected from the group of methyl carbamate, ethyl carbamate, n-propyl carbamate, isopropyl carbamate, n-butyl carbamate, isobutyl carbamate, tert-butyl carbamate, n-hexyl carbamate, 2-ethylhexyl carbamate, cyclohexyl carbamate, phenyl carbamate, and mixtures thereof, preferably methyl carbamate.

Embodiment 35: coating composition according any of the preceding embodiments, wherein the at least one carbamate compound is reacted with the ethylene copolymer EC in a molar ratio of carbamate compound to hydroxyl groups present in the ethylene copolymer EC of 10:1 to 1:1, preferably 5:1 to 1:1, very preferably 2:1 to 1:1.

Embodiment 36: coating composition according to any of the preceding embodiments, wherein the at least one catalyst is selected from tin containing catalysts, titanium (IV) alkoxides, zirconium (IV) acetylacetonate, bismuth-containing catalysts and mixtures thereof, preferably tin containing catalysts.

Embodiment 37: coating composition according to embodiment 36, wherein the tin containing catalyst is selected from dialkyltin carboxylates, dialkyltin oxides and mixtures thereof, preferably dialkyltin oxides, very preferably dibutyltin oxide.

Embodiment 38: coating composition according to embodiment 36 or 37, wherein the titanium (IV) alkoxide has n alkoxide groups, wherein n is an integer from one to four and each alkoxide group has 1 to 8 carbon atoms, and 4-n groups selected from halogen groups, acetylacetonate groups, and ethanolaminato groups, very preferably n is 4 and each alkoxide is selected from isopropoxide.

Embodiment 39: coating composition according any of the preceding embodiments, wherein the at least one catalyst, preferably dibutyltin oxide or zirconium (IV) acetylacetonate, is used in a total amount of 0.01 to 2 wt. %, preferably 0.05 to 0.8 wt. %, more preferably 0.08 to 0.5 wt. %, very preferably 0.1 to 0.4 wt. %, based on each case on the total amount of the ethylene copolymer EC and the carbamate compound.

Embodiment 40: coating composition according any of the preceding embodiments, wherein reaction between the at least one ethylene copolymer EC and the at least one carbamate compound in the presence of the at least one catalyst is carried out at a temperature of 120 to 140° C.

Embodiment 41: coating composition according any of the preceding embodiments, wherein the reaction between the at least one ethylene copolymer EC and the at least one carbamate compound in the presence of the at least one catalyst is carried out in an organic solvent, said solvent being preferably selected from aromatic hydrocarbons, preferably toluene, xylene, mesitylene, 2-, 3-, or 4-ethyltoluene; naphthas; aliphatic and cycloaliphatic hydrocarbons, preferably cyclohexanone, white spirits, mineral turpentine, tetralin and decalin; ketones, and mixtures thereof, preferably toluene and/or cyclohexanone and/or aromatic hydrocarbons.

Embodiment 42: coating composition according any of the preceding embodiments, wherein the reaction between the at least one ethylene copolymer EC and the at least one carbamate compound in the presence of the at least one catalyst is carried out in an organic solvent mixture comprising toluene and cyclohexanone or toluene and aromatic hydrocarbons or cyclohexanone and aromatic hydrocarbons, wherein said solvent mixture contains at least 50 wt. %, preferably 50 to 60 wt. %, of cyclohexanone or aromatic hydrocarbons, based on the total weight of the solvent mixture.

Embodiment 43: coating composition according to any of the preceding embodiments, wherein the coating composition comprises the at least one binder B containing at least one carbamate group in a total amount of 0.1 to 50 wt. % solids, preferably 1 to 40 wt. % solids, more preferably 5 to 35 wt. % solids, very preferably 12 to 30 wt. % solids, based in each case on the total weight of the coating composition.

Embodiment 44: coating composition according to any of the preceding embodiments, wherein the at least one crosslinking agent CA is selected from melamine resins, blocked and/or unblocked polyisocyanates, polycarbodiimides, triazines, preferably trialkoxycarbamatotriazine, polyfunctional acid resins and mixtures thereof, preferably melamine resins and/or blocked polyisocyanates.

Embodiment 45: coating composition according to any of the preceding embodiments, wherein the at least one crosslinking agent CA is present in a total amount of 1 to 30 wt. % solids, preferably 3 to 25 wt. % solids, more preferably 4 to 20 wt. % solids, very preferably 5 to 15 wt. % solids, based in each case on the total weight of the coating composition.

Embodiment 46: coating composition according to any of the preceding embodiments, wherein the coating composition further comprises at least one crosslinking catalyst CAT.

Embodiment 47: coating composition according to embodiment 46, wherein the at least one crosslinking catalyst CAT is selected from tin containing catalysts, bismuth containing catalysts, zirconium containing catalysts, lithium containing catalysts and mixtures thereof, preferably dibutyltin diacetate, bismuth carboxylates, zirconium carboxylates, lithium carboxylates and mixtures thereof.

Embodiment 48: coating composition according to embodiment 46 or 47, wherein the at least one crosslinking catalyst CAT, preferably dibutyltin diacetate, bismuth carboxylates, zirconium carboxylates, lithium carboxylates and mixtures thereof, is present in a total amount of 0.005 to 1 wt. %, preferably 0.08 to 0.2 wt. %, based in each case on the total weight of the coating composition.

Embodiment 49: coating composition according to any of the preceding embodiments, wherein the coating composition further comprises at least one binder B1, said binder B1 being different from binder B.

Embodiment 50: coating composition according embodiment 49, wherein the at least one further binder B1 is selected from (i) carbamate-functional materials, preferably carbamate-functional acrylic polymers, carbamate-functional polycarbonates, carbamate-functional polyesters and mixtures thereof; (ii) hydroxy-functional materials, preferably hydroxy-functional poly (meth)acrylates, hydroxy-functional polyurethanes, hydroxy-functional polyurethane (meth)acrylate hybrid polymers, hydroxy-functional polyesters, hydroxy-functional polyethers and mixtures thereof; (iii) carboxylic acid-functional materials; (iv) epoxy-functional materials; and (v) mixtures of the aforelisted materials, preferably carbamate-functional acrylic polymers, carbamate-functional polycarbonates, carbamate-functional polyesters, hydroxy-functional poly(meth)acrylates and mixtures thereof.

Embodiment 51: coating composition according embodiment 49 or 50, wherein the at least one further binder B1 is present in a total amount of 0.1 to 50 wt. % solids, preferably 5 to 45 wt. % solids, more preferably 10 to 40 wt. % solids, very preferably 25 to 35 wt. % solids, based in each case on the total weight of the coating composition.

Embodiment 52: coating composition according any of embodiments 49 to 51, wherein the at least one carbamate-functional ethylene copolymer B is preferably present in a total amount of at least 30 mol %, very preferably from 30 to 100 mol %, based on the total carbamate equivalent of all carbamate-functional materials present in the coating composition.

Embodiment 53: coating composition according to any of the preceding embodiments, wherein the coating composition further comprises at least one additive selected from the group consisting of (i) UV absorbers; (ii) light stabilizers such as HALS compounds, benzotriazoles or oxalanilides; (iii) rheology modifiers such as sagging control agents (urea crystal modified resins), organic thickeners and inorganic thickeners; (iv) free-radical scavengers; (v) slip additives; (vi) polymerization inhibitors; (vii) defoamers; (viii) wetting agents; (ix) fluorine compounds; (x) adhesion promoters; (xi) leveling agents; (xii) film-forming auxiliaries such as cellulose derivatives; (xiii) fillers, such as nanoparticles based on silica, alumina or zirconium oxide; (xiv) flame retardants; and (xv) mixtures thereof.

Embodiment 54: coating composition according to any of the preceding embodiments, wherein it is a one-component or a two-component coating composition.

Embodiment 55: coating composition according to any of the preceding embodiments, wherein it is a clearcoat composition or a tinted clearcoat composition.

Embodiment 56: coating composition according any of the preceding embodiments, wherein the coating composition comprises 0 to 20 wt. %, preferably 0 to 10 wt. %, more preferably 0 to 5 wt. %, and very preferably 1 to 5 wt. % of water, based in each case on the total weight of the coating composition.

Embodiment 57: coating composition according any of the preceding embodiments, wherein the coating composition has a solids content of 30 to 80 wt. %, very preferably 50 to 60 wt. %, based in each case on the total weight of the coating composition.

Embodiment 58: method for producing at least one coating on a substrate, comprising
(1) optionally applying a pigmented basecoat composition to the substrate, forming a coating film from said basecoat composition and optionally curing said basecoat film;
(2) applying a coating composition as claimed in any of embodiments 1 to 57 to the substrate or the coated substrate obtained after step (1);
(3) forming a coating film from the composition applied in step (2); and
(4) curing the coating film(s) obtained after step (1) and/or (3).

Embodiment 59: method according to embodiment 58, where said method is used for producing at least one coating layer, more particularly a clearcoat coating layer, for automotive OEM finishing and/or for the finishing of parts for installation in or on automobiles and/or for the finishing of commercial vehicles and/or for automotive refinishing.

Embodiment 60: method according to embodiment 58 or 59, characterized in that the substrate is selected from metallic substrates, metallic substrates coated with a cured electrocoat and/or a cured filler, plastic substrates and substrates comprising metallic and plastic components, preferably from metallic substrates.

Embodiment 61: method according to embodiment 58, characterized in that the metallic substrate is selected from the group comprising or consisting of iron, aluminum, copper, zinc, magnesium and alloys thereof as well as steel.

Embodiment 62: coating obtained by a method as claimed in any of embodiments 58 to 61.

Embodiment 63: use of a coating composition as claimed in any of embodiments 1 to 57 for improving the scratch resistance of coating layers, especially of clear coating layers.

### Examples

The present invention will now be explained in greater detail through the use of working examples, but the present invention is in no way limited to these working examples. Moreover, the terms “parts”, “%” and “ratio” in the examples denote “parts by mass”, “mass %” and “mass ratio” respectively unless otherwise indicated.

1. Methods of Determination:

1.1 Number-Average Molecular Weight (Mₙ), Weight-Average Molecular Weight (M_{w}), and Polydispersity Index (PDI)

The number-average molecular weight distribution (Mₙ) and the weight-average molecular weight distribution (M_{w}) were, unless otherwise indicated, determined via GPC. The polydispersity (PDI) was calculated as PDI=(M_{w}/Mₙ). The GPC analysis was made with a RI (refraction index) detector, a column temperature of 35° C. and THF with 0.1% trifluoro acetic acid as elution medium. The calibration was done with very narrow distributed polystyrene standards from the Polymer Laboratories with a molecular weight M_{w}=from 580 until 6,870,000 g/mol.

1.2 Amount of Ethylene, Compound C1 and Compound C2 Present in Polymerized Form in the Ethylene Copolymer EC

The amount of ethylene as well as polymerizable compounds C1 and C2 present in polymerized form in the ethylene copolymer EC is determined by ¹H-NMR, a method know to the skilled person.

1.3 Solid Content (Solids, Non-Volatile Fraction)

Unless otherwise indicated, the solids content, also referred to as solid fraction or non-volatile fraction hereinafter, was determined in accordance with ASTM D2369-20 at 110° C.; 60 min, initial mass 0.3 to 0.5 g.

1.4 Hydroxyl Number (OH Number)

The hydroxyl number of the ethylene copolymer EC is calculated using the amount of hydroxyl containing compound C1 in the ethylene copolymer EC.

1.5 Glass Transition Temperature (T_{g})

The glass transition temperature (T_{g}) of the ethylene copolymer EC and the carbamate-functional binder B was determined by DSC using a TA Instruments Q2000. The sample was run from −90 to 180° C. at 15° C./min twice, with a 60 minute isothermal hold at 180° C. after the first heat. The T_{g} was measured on the second run.

1.6 Carbamate Equivalent

The carbamate equivalent of the carbamate-functional binders was determined by comparing the proton integration of carbamate group to the OH group in the ¹H NMR spectrum of binder B.

2. Synthesis of Different Binders

### Abbreviations of Components

E: ethylene
NBA: N-butyl acrylate
Sty: Styrene
MAA: Methyl methacrylic acid
MMA: Methyl methacrylate
HEMA: Hydroxyethyl methacrylate
HPMA: 2-Hydroxypropyl methacrylate
EHMA: 2-Ethylhexyl methacrylate
CHMA: Cyclohexyl methacrylate
GMA: Glycidyl methacrylate
EHA: 2-ethylhexyl acrylate
PA: Propionaldehyde
MEK: Methylethylketone

2.1 Synthesis of Ethylene Copolymers B-I1 to B-I6 Having at Least One Carbamate Group

2.1.1 Synthesis of Ethylene Copolymers EC-1 to EC-6

A high-pressure autoclave of the type described in the literature (M. Buback et al., Chem. Ing. 25 Tech. 1994, 66, 510-513) was used for continuous copolymerization.

Ethylene was fed continuously into a first compressor until approximately 250 bar were reached. Separately from this, the respective amount of HEMA and alkyl (meth)acrylate (NBA or EHA or MMA) was also compressed continuously to an intermediate pressure of 250 bar and was mixed with the ethylene feed. The ethylene/acrylate mixture was further compressed using a second compressor. The reaction mixture is fed to a 1-liter autoclave having the pressure and temperature listed in Table 1. The desired temperature is maintained by the adjusting the amount of initiator tert-amyl peroxypivalate in isodecane, which is introduced to the autoclave separately from the monomer feed (about 1,000 to 1,500 ml/h).

Separately from this, the amount of chain transfer agent (cf. Table 1 “Regulator Feed”) was first compressed to an intermediate pressure of 250 bar and then compressed with the aid of a further compressor before it was fed continuously into the high-pressure autoclave.

The output of each polymerization reaction listed in Table 1 was usually around 5 to 6 kg/h at a conversion of 30 to 45 wt. % (based on total feed, i.e. ethylene and further monomers). Details of the reaction conditions are summarized in Table 1. The analytical data of the prepared ethylene copolymers EC-1 to EC-6 is summarized in Table 2.

TABLE 1
Reaction conditions

| Ethylene | | | | | | |
|---|---|---|---|---|---|---|
| copolymer | | | T | Ethylene | Acrylate feed | |
| EC | Reactants | P [bar] | [° C.] | feed [g/h] | [g/h] | Regulator feed [g/h] |
| EC-1 | E, HEMA | 1,800 | 200 | 12,310 | HEMA: 2,218 | PA: 1,200 (6.7 wt. %) |
| | | | | | | MEK: 2,218 (12.3 wt. %) |
| EC-2 | E, HEMA, | 1,800 | 201 | 12,160 | HEMA: 2,185 | PA: 1,200 (6.3 t. %) |
| | NBA | | | | NBA: 1,180 | MEK: 2,185 (11.55 wt. %) |
| EC-3 | E, HEMA, | 1,800 | 200 | 12,035 | HEMA: 1,905 | PA: 1,200 (6.2 wt. %) |
| | EHA | | | | EHA: 2,200 | MEK: 1,905 (9.8 wt. %) |
| EC-4 | E, HEMA, | 1,794 | 200 | 12,070 | HEMA: 2,175 | PA: 1,200 (6.4 wt. %) |
| | MMA | | | | MMA: 1,100 | MEK: 2,175 (11.6 wt. %) |
| EC-5 | E, HEMA, | 1,829 | 199 | 11,990 | HEMA: 2,238 | PA: 800 (4.3 wt. %) |
| | EHA, MMA | | | | EHA: 600 | MEK: 2,238 (12.3 wt. %) |
| | | | | | MMA: 600 | |
| EC-6 | E, HEMA, | 1,800 | 200 | 11,990 | HEMA: 2,250 | PA: 1,200 (6.3 wt. %) |
| | EHA, MMA | | | | EHA: 600 | MEK: 2,250 (11.9 wt. %) |
| | | | | | MMA: 600 | |

TABLE 2
Analytical data of obtained ethylene copolymers EC-1 to EC-6

| | | Ethylene copolymer | | | | | |
|---|---|---|---|---|---|---|---|
| | | EC-1 | EC-2 | EC-3 | EC-4 | EC-5 | EC-6 |
| Monomer | Ethylene | 50.0 | 34.0 | 36.2 | 40.0 | 40.0 | 40.0 |
| composition | 2-hydroxy ethyl methacrylate (HEMA) | 50.0 | 46.0 | 32.1 | 40.0 | 40.0 | 40.0 |
| (wt. %) | n-Butyl acrylate (NBA) | — | 20.0 | — | — | — | — |
| | 2-ethylhexyl acrylate (EHA) | — | — | 30.6 | — | 10.0 | 10.0 |
| | Methyl methacrylate (MMA) | — | — | — | 20.0 | 10.0 | 10.0 |
| | Total | 100 | 100 | 100 | 100 | 100 | 100 |

| | | | | | | |
|---|---|---|---|---|---|---|
| Number-average molecular weight (Mₙ) [g/mol] | 2,317 | 2,814 | 2,930 | 3,049 | 3,801 | 2,713 |
| Weight-average molecular weight (M_{w}) [g/mol] | 4,391 | 6,247 | 6,880 | 6,518 | 8,680 | 6,494 |
| Polydispersity (PD) | 1.9 | 2.2 | 2.3 | 2.1 | 2.3 | 2.4 |
| Hydroxyl number [mg KOH/g] | 215.6 | 198.3 | 137.6 | 172.5 | 172,5 | 172.5 |
| Glass transition temperature (T_{g}) [° C.] | −32.6 | −32.6 | −45.4 | −20.8 | −25.7 | −31.6 |
| Non-volatile content (wt. %) | 100 | 100 | 100 | 100 | 100 | 100 |

2.1.2 Reaction of Ethylene Copolymers EC-1 to EC-6 with at Least One Carbamate Compound in the Presence of at Least One Catalyst

a) Preparation of Binders B-I2 to B-I6

The reaction of the ethylene copolymers EC-2 to EC-6 prepared according to point 2.1.1 with methyl carbamate in the presence of dibutyltin oxide (DBTO) was performed according to the following general procedure using the amounts listed in Table 3 below: A mixture of the respective ethylene copolymer, methyl carbamate, dibutyltin oxide, Solvesso 100 and toluene was heated under an inert atmosphere to reflux in a reactor equipped with an extractor that can remove the azeotrope of the formed methanol and cyclohexanone. Once at reflux, the inert atmosphere was turned off. Cyclohexanone was recycled during the reaction and the reaction temperature was controlled between 120 and 130° C. The reaction was stopped after around 14 hours from the beginning of reflux. Free methyl carbamate, cyclohexanone and toluene was removed by vacuum distillation at a temperature below 110° C. The degree of conversion is calculated based on proton integration of the carbamate group to the OH group in the ¹H-NMR spectra of the respective obtained binder B. The carbamated product was diluted with Solvesso 100 (binder B-I3 to B-I6) or Solvesso 100 and cyclohexanone at a ratio of 1:1.5 (binder B-I2) to the respective nonvolatile content stated in Table 3.

b) Preparation of Binder B-I1

A mixture of 478.65 parts of ethylene copolymer EC-1, 151.71 parts of methylcarbamate, 1.8389 parts of DBTO, 137.78 parts of toluene and 158.37 parts of Solvesso 100 was heated under an inert atmosphere to reflux in a reactor equipped with an extractor that can remove the azeotrope of methanol and toluene. Once at reflux, the inert atmosphere was turned off. About 400.00 parts of toluene was added during the reaction to maintain the reflux, and the reaction temperature was controlled between 120 to 140° C. The reaction was stopped after 13 h, and free methylcarbamate and the solvent was removed by vacuum distillation at the temperature below 110° C. The obtained carbamated product was diluted with cyclohexanone to a nonvolatile content of 65 wt. %. The degree of conversion is 90.3% (based on proton integration of the carbamate group to the OH group in the ¹H-NMR spectra).

c) Preparation of Binder B-I7

A mixture of 354.76 parts of ethylene copolymer EC-5, 123.33 parts of methylcarbamate, 1.6960 parts of zirconium(IV) acetylacetonate, 150.00 parts of cyclohexane and 180.00 parts of Solvesso 100 was heated under an inert atmosphere to reflux in a reactor equipped with an extractor that can remove the azeotrope of methanol and cyclohexane. Once at reflux, the inert atmosphere was turned off. Cyclohexane was recycled during the reaction, and the reaction temperature was controlled between 120 to 140° C. The reaction was stopped after 10 h because it was observed that the final product had a significant M_{w} shift compared to the DBTO catalyzed transcarbamation. Free methylcarbamate and the solvent was removed by vacuum distillation at the temperature below 110° C. The carbamated product was diluted with cyclohexanone to a nonvolatile content of 68 wt. %. The degree of conversion is 71.6% (based on proton integration of the carbamate group to the OH group in the ¹H-NMR spectra).

The properties of the prepared carbamate-functional binders B-I1 to B-I7 are listed in Table 4.

TABLE 3
Amounts (in parts by weight) and compounds used in the synthesis of carbamate-functional
binders B-I2 to B-6

| | | | | | | Degree of | Nonvolatile |
|---|---|---|---|---|---|---|---|
| | Ethylene | Methyl | Dibutyltin | | Solvesso | conversion | content |
| Binder | copolymer | carbamate | oxide | Cyclohexanone | 100 | [%] | [wt. %] |
| B-I2 | EC-2: 228.3 | 121.3 | 0.4985 | 75.18 | 106.2 | 96.5 | 65 |
| B-I3 | EC-3: 458.2 | 133.2 | 0.7142 | 151.3 | 221.4 | 96.4 | 70 |
| B-I4 | EC-4: 167.6 | 58.85 | 0.3180 | 55.30 | 78.70 | 96.7 | 73 |
| B-I5 | EC-5: 393.8 | 136.7 | 0.7300 | 150.0 | 200.0 | 93.1 | 80 |
| B-I6 | EC-6: 396.2 | 140.7 | 0.7300 | 150.0 | 200.0 | 95.2 | 65 |

TABLE 4
Properties of prepared carbamate-functional binders B-I1 to B-I7

| | Carbamate-functional binder B | | | | | | |
|---|---|---|---|---|---|---|---|
| | B-I1 | B-I2 | B-I3 | B-I4 | B-I5 | B-I6 | B-I7 |
| Number-average molecular weight (Mₙ) | 3,217 | 3,185 | 5,195 | 5,198 | 3,915 | 3,939 | 5,773 |
| [g/mol] | | | | | | | |
| Weight-average molecular weight (M_{w}) | 8,140 | 9,138 | 10,579 | 8,911 | 10,786 | 8,836 | 14,040 |
| [g/mol] | | | | | | | |
| Polydispersity (PD) | 2.5 | 2.9 | 2.0 | 1.7 | 2.8 | 2.2 | 2.4 |
| Glass transition temperature (T_{g}) [° C.] | −12.9 | −7.8 | −25.8 | −3.2 | −10.2 | −5.8 | n.d.¹⁾ |
| Carbamate equivalent | 331.3 | 336.2 | 463.6 | 379.5 | 391.8 | 384.8 | 497.4 |

¹⁾not determined

2.2 Synthesis of Comparative Acrylic Binder B-C1 Comprising Carbamate Groups

A reactor flushed with nitrogen and fitted with a condenser was charged with 175.54 parts of Solvesso® 100, 7.565 parts of methylcarbamate and 0.4600 parts of dibutyltin oxide, and this initial charge was heated to 142° C. with stirring. To this reaction mixture, a mixture of 2.62 parts of methacrylic acid, 265.10 parts of 2-hydroxyethyl methacrylate, 52.12 parts of 2-ethylhexyl methacrylate, 371.42 parts of 2-ethylhexyl acrylate, 52.12 parts styrene, 88.90 parts of 2,2′-azobis(2-methylbutyronitrile) (VAZO 67), 73.52 parts of Solvesso® 100, and 72.06 parts of toluene were metered in at a uniform rate over a time of 270 minutes. After the end of the metered addition, 224.94 parts of toluene was added into the reaction mixture, and the reaction temperature was cooled to 127° C. To this reaction mixture, 4.6800 parts of dibutyltin oxide was added, and the reaction mixture was heated under an inert atmosphere to reflux so the azeotrope of methanol and toluene can be removed. Once at reflux, the inert atmosphere was turned off, and 145.54 parts of toluene was slowly added to the reactor over the course of the transcarbamation to offset the loss of toluene and to maintain the reflux temperature to be <131° C. The reaction was stopped when more than 90% of the hydroxyl groups were converted to carbamate groups. Free methylcarbamate and the solvent was removed by vacuum distillation, and amyl acetate was added to adjust the nonvolatile content of the resin to 70 wt. %.

The properties of the obtained comparative carbamate-functional acrylic resin B-C1 is listed in Table 5:

| | B-C1 |
|---|---|
| Hydroxyl number [mg KOH/g] | <14.6 |
| Glass transition temperature (T_{g}) [° C.] | 0 |
| Non-volatile content (%) | 70 |
| Weight-average molecular weight (M_{w}) [g/mol] | 4,000 |
| Carbamate equivalent | 425 |

2.3 Preparation of Carbamate Functional Oligomer

The carbamate functional oligomer was prepared by mixing 50% of solid weight of the reactive component (a) described in U.S. Pat. No. 6,962,730 B2 and 50% of solid weight of the resin described in example 1 of U.S. Pat. No. 5,719,237 A. The carbamate equivalent of said mixture is 720.7.

3. Preparation of Coating Compositions

The clearcoat compositions listed in Table 6 were prepared by mixing the ingredients and stirring until a homogenous clearcoat composition is obtained.

TABLE 6
Ingredients of inventive clearcoat compositions C-I1 to C-I3 and comparative
clearcoat compositions C-C1 to C-C3 (amounts in wt. %, based on the total weight of
the respective clearcoat composition)

| | Clearcoat composition | | | | | |
|---|---|---|---|---|---|---|
| Ingredient | C-C1 | C-C2 | C-I1* | C-C3 | C-I2* | C-I3* |
| Binder B-I2 | — | — | 20.7 | — | — | — |
| Binder B-I5 | — | — | — | — | 35.2 | — |
| Binder B-I6 | — | — | — | — | — | 38.9 |
| Binder B-C1 | 20.2 | 20.3 | 7.9 | 37.6 | — | — |
| Carbamate functional | 15.6 | 15.6 | 14.8 | 14.0 | 13.1 | 13.5 |
| oligomer | | | | | | |
| Fumed silica dispersion ¹⁾ | — | 3.3 | — | — | — | — |
| Epoxy acrylic resin ²⁾ | 1.7 | 1.7 | 1.6 | — | — | — |
| Acrylic Resin ³⁾ | 4.7 | 4.7 | — | — | — | — |
| Melamine resin ⁴⁾ | 9.6 | 9.6 | 9.3 | 8.9 | 8.9 | 9.2 |
| Isocyanate crosslinker ⁵⁾ | 2.7 | 2.7 | 2.5 | — | — | — |
| UV absorber ⁶⁾ | 4.1 | 4.1 | 3.9 | 4.3 | 4.1 | 4.2 |
| HALS ⁷⁾ | 0.51 | 0.51 | 0.48 | 0.53 | 0.51 | 0.52 |
| Rheology Agent 1 ⁸⁾ | 14.5 | 14.5 | 13.7 | 17.9 | 17.0 | 17.4 |
| Rheology Agent 2 ⁹⁾ | 13.7 | 14.4 | 13.7 | 9.03 | 8.59 | 8.81 |
| Rheology Agent 3 ¹⁰⁾ | 0.20 | 0.20 | 0.19 | 0.25 | 0.24 | 0.25 |
| anti-popping additive ¹¹⁾ | 0.02 | 0.02 | 0.02 | 0.02 | 0.02 | 0.02 |
| flow additive ¹²⁾ | 0.14 | 0.14 | 0.14 | 0.15 | 0.14 | 0.15 |
| Tin Catalyst ¹³⁾ | 0.19 | 0.19 | 0.18 | — | — | — |
| Acid Catalyst ¹⁴⁾ | 2.8 | 2.8 | 2.7 | 2.7 | 2.6 | 2.7 |
| Solvent ¹⁵⁾ | 9.4 | 5.3 | 8.2 | 4.6 | 9.7 | 4.5 |
| Non-volatile content [%] | 54 | 55 | 55 | 57 | 57 | 57 |
| Total carbamate equivalent | 1,340 | 1,312 | 1,076 | 1,063 | 1,026 | 1,039 |
| fraction of carbamate- | | | | | | |
| functional ethylene | | | | | | |
| copolymer on total | 0 | 0 | 43 | 0 | 69 | 73 |
| carbamate equivalent | | | | | | |
| [mol %] | | | | | | |

*inventive
¹⁾ Aerodisp ® 1030 (supplied by Evonik Corporation)
²⁾ weight per epoxy = 381 g/mol, solids = 59.4%, T_{g} = −31° C., monomer composition (wt. %, based on total weight of epoxy acrylic resin): sty/MMA/HPMA/HPA/GMA/EHA/acetic anhydride = 0.971/0.971/1.85/1.85/31.8/56.2/2.13
³⁾ M_{w} = 4,600 g/mol, hydroxyl number = 182 mg KOH/g solids, solids = 67.5%, T_{g} = 34° C., monomer composition (wt. %, based on the total weight of the acrylic resin): MAA/HPMA/EHMA/EHA/CHMA = 0.419/46.2/23.3/11.1/19.0
⁴⁾ Resimene 747 (supplied by Ineos)
5⁾ DESMODUR PL 350 MPA/SN (supplied by Covestro)
⁶⁾ Tinuvin ® 928 (supplied by BASF SE)
⁷⁾ Tinuvin ® 123 (supplied by BASF SE)
⁸⁾ 28.9% silica in acrylic resin (see footnote 2)
⁹⁾ 2.72% Diurea crystals in binder B-C1
¹⁰⁾ BYK-LP R 23429 (solution of polyhydroxycarboxylic acid amides)
¹¹⁾ Flowlen AC-300 (supplied by Kyoeisha Chemical)
¹²⁾ Lindron 22 PolyButyl Acrylate (commecially available from Lindau Chemicals)
¹³⁾ Fascat ® 4200 (supplied by PMC Organometallix)
¹⁴⁾ mixture of carboxylic acid, sulfonic acid and blocked sulfonic acid
¹⁵⁾ mixture of EXXAL 13, ethyl 3-ethoxyproprionate, n-butanol, Dowanol PM, amyl acetate

To keep the non-volatile content of comparative and inventive clearcoat compositions C-C1, C-C2 and C-I1 constant, the amount of the ingredients had to be adapted respectively. Due to the low solubility of binder B-I2, the total carbamate equivalent of inventive coating composition C-I1 is lower than the total carbamate equivalent of comparative coating compositions C-C1 and C-C2. The same applies to clearcoat compositions C-C3, C-I2 and C-I3. In this case, the amount of ingredients had to be adapted to keep the non-volatile content constant and the total carbamate equivalent within the same range.

4. Evaluation of Physical Properties of Coating Films

4.1 Preparation of Coating Films

Coating films are obtained from the coating compositions listed in Table 6 by applying the respective coating composition with a SATA Gravity feed gut at a target film build thickness of 1.8 to 2.2 mils on a free tedlar film attached to 4×12 CRS panels and curing the applied coating composition at 140° C. for 25 minutes.

4.2 Glass Transition Temperature T_{g} and Storage Modulus (E′)

The glass transition temperature T_{g} of the coating films prepared according to point 4.1 was determined with DMTA (dynamic mechanical thermo analysis) using a TA Instruments DMA 850. The T_{g} is corresponding to the temperature of the highest tan δ, which is measured at a frequency of 1 Hz on film clamps at a temperature increase of 3° C. per minute from −30 to 0° C. and a temperature increase of 2° C. per minute from 0 to 200° C. The storage modulus E′ is the minimum at rubbery plateau in obtained DMTA curves.

4.2 Measurement of Further Mechanical Properties

The tensile modulus and strain at break as well as the Pa-% integration of the coating films prepared according to point 4.1 was determined by DMTA (dynamic mechanical thermo analysis) using a TA Instruments DMA 850 under a strain rate of 3% per min at 25° C. Three replicates were tested for each sample.

4.3 Tukon Hardness

The Tukon Hardness was determined according to ASTM D-1474 (2018).

5. Preparation of Coated Substrates and Evaluation of Clearcoat Layer

5.1 Preparation of Coated Substrates

The clearcoat compositions described in Table 6 were each applied with an air atomized spray gun, wet-on-wet, over a conventional black solvent-based basecoat (Shadow Black high solids basecoat from BASF Japan Co.). The basecoats were sprayed over a 4″×12″ electrocoated steel panel (electrocoated using Cathoguard® 800 from BASF Japan) and dried for 10 minutes at 23° C. The basecoat film thickness was 0.7 mils, and the clearcoat film builds were from about 1.8 to about 2.0 mils. After application, the panels were allowed to flash at ambient temperature for 10 minutes, then baked in a gas fired convection oven for 25 minutes at 140° C. metal temperature. Afterwards, the properties of each clearcoat layer were determined with the methods described hereinafter.

5.2 Evaluation of Clearcoat Layers

5.2.1 Dry Scratch Resistance

Dry scratch resistance was carried out with a crock meter (M238BB Electronic Crockmeter, SDL Atlas) equipped with a micro-scratch head having a width of 25 mm (±0.5 mm) and a curvature with a radius of 19 mm (±0.5 mm). The micro-scratch head is first covered with black EPDM open cell foam with a Shore 00 hardness of 60±5, and is then covered with an 5 μm Aluminum Oxide Lapping Polyester film (261X, lot #2533-5, from 3M). The applied force to the panel is around 9 N, the length of the scratch line is 11 cm and the speed of the crockmeter is 1 Hz. The movement of the micro scratch head relative to the panel is perpendicular to the axis of the surface curvature.

The initial gloss of the samples (20°) was measured perpendicularly to the length of the panels (which will also be the scratching direction) on 3 panels at 4 locations evenly distributed on each panel, the average value for each sample being reported as initial gloss. Gloss was measured with a gloss-meter (micro-tri-gloss, BYK-GARDENER). Five back and forth (double stroke) movement were performed with the crock meter, while correctly maintaining the panel on the device. Two new scratches were made on each of the 3 panels. Gloss after scratching (20°) is measured immediately, 24 h±30 min, and 168 h±1 h, after each individual scratch line is made. Samples are stored at ambient temperature (23° C.). The gloss retention is calculated by dividing the average gloss obtained from all post scratch measurements of each scratch line by the average of the gloss measurements made on the panel before it was scratched according to the following formula:

Gloss retention [%]=(average gloss from all post scratch measurements/average initial gloss)*100

5.2.2 Chip Test

The chip test was performed according to SAE-J400 (2012 Oct. 23).

5.2.3 BAAT Test

The BAAT test was performed according to ASTM D 7356-07.

5.3 Results

5.3.1 Results of Physical Properties and Dry Scratch Resistance

The results obtained for the physical properties of the clearcoat films produced according to point 4.1 and the dry scratch resistance of clearcoat layers produced according to point 5.1 are shown in Tables 7 and 8 (the footnotes of Tables 7 and 8 correspond to the footnotes of Table 6).

TABLE 7
Physical properties of inventive and comparative clearcoat layers CL
prepared according to point 4.1

| | Clearcoat layer | | | | |
|---|---|---|---|---|---|
| | CL-C1 | CL-I1* | CL-C3 | CL-I2* | CL-I3* |
| Clearcoat composition | C-C1 | C-I1 | C-C3 | C-I2 | C-I3 |
| Binder B-I2 | — | 20.7 | — | — | — |
| Binder B-I5 | — | — | — | 35.2 | — |
| Binder B-I6 | — | — | — | — | 38.9 |
| Binder B-C1 | 20.2 | 7.9 | 37.6 | — | — |
| Carbamate functional | 15.6 | 14.8 | 14.0 | 13.1 | 13.5 |
| oligomer | | | | | |
| Fumed silica dispersion ¹⁾ | — | — | — | — | — |
| Epoxy acrylic resin ²⁾ | 1.7 | 1.6 | — | — | — |
| Acrylic Resin ³⁾ | 4.7 | — | — | — | — |
| Melamine resin ⁴⁾ | 9.6 | 9.3 | 8.9 | 8.9 | 9.2 |
| Isocyanate crosslinker ⁵⁾ | 2.7 | 2.5 | — | — | — |
| UV absorber ⁶⁾ | 4.1 | 3.9 | 4.3 | 4.1 | 4.2 |
| HALS ⁷⁾ | 0.51 | 0.48 | 0.53 | 0.51 | 0.52 |
| Rheology Agent 1 ⁸⁾ | 14.5 | 13.7 | 17.9 | 17.0 | 17.4 |
| Rheology Agent 2 ⁹⁾ | 13.7 | 13.7 | 9.03 | 8.59 | 8.81 |
| Rheology Agent 3 ¹⁰⁾ | 0.20 | 0.19 | 0.25 | 0.24 | 0.25 |
| anti-popping additive ¹¹⁾ | 0.02 | 0.02 | 0.02 | 0.02 | 0.02 |
| flow additive ¹²⁾ | 0.14 | 0.14 | 0.15 | 0.14 | 0.15 |
| Tin Catalyst ¹³⁾ | 0.19 | 0.18 | — | — | — |
| Acid Catalyst ¹⁴⁾ | 2.8 | 2.7 | 2.7 | 2.6 | 2.7 |
| Solvent ¹⁵⁾ | 9.4 | 8.2 | 4.6 | 9.7 | 4.5 |
| Glass transition | 106.7 | 105.5 | 110 | 112 | 113 |
| temperature Tg [° C.] | | | | | |
| Strain at break [%] | 11.1 | 15.2 | 14.0 | 19.5 | 27.0 |
| Tukon Hardness [knh] | 9.57 | 10.4 | 10.4 | 13 | 11.7 |
| E at break [MPa] | 27 | 31 | 26 | 37 | 36 |
| E′ at rubbery plateau | 35 | 15 | 18 | 23 | 23 |
| [MPa] | | | | | |

*inventive

TABLE 8
Gloss retention of inventive and comparative multilayer
coatings MC prepared according to point 5.1

| | Multilayer coating | | | | | |
|---|---|---|---|---|---|---|
| | MC1 | MC2 | MC3* | MC4 | MC5* | MC6* |
| Clearcoat | C-C1 | C-C2 | C-I1 | C-C3 | C-I2 | C-I3 |
| composition | | | | | | |
| Binder B-I2 | — | — | 20.7 | — | — | — |
| Binder B-I5 | — | — | — | — | 35.2 | — |
| Binder B-I6 | — | — | — | — | — | 38.9 |
| Binder B-C1 | 20.2 | 20.3 | 7.9 | 37.6 | — | — |
| Carbamate | 15.6 | 15.6 | 14.8 | 14.0 | 13.1 | 13.5 |
| functional | | | | | | |
| oligomer | | | | | | |
| Fumed silica | — | 3.3 | — | — | — | — |
| dispersion ¹⁾ | | | | | | |
| Epoxy acrylic | 1.7 | 1.7 | 1.6 | — | — | — |
| resin ²⁾ | | | | | | |
| Acrylic Resin ³⁾ | 4.7 | 4.7 | — | — | — | — |
| Melamine resin ⁴⁾ | 9.6 | 9.6 | 9.3 | 8.9 | 8.9 | 9.2 |
| Isocyanate | 2.7 | 2.7 | 2.5 | — | — | — |
| crosslinker ⁵⁾ | | | | | | |
| UV absorber ⁶⁾ | 4.1 | 4.1 | 3.9 | 4.3 | 4.1 | 4.2 |
| HALS ⁷⁾ | 0.51 | 0.51 | 0.48 | 0.53 | 0.51 | 0.52 |
| Rheology Agent | 14.5 | 14.5 | 13.7 | 17.9 | 17.0 | 17.4 |
| 1 ⁸⁾ | | | | | | |
| Rheology Agent | 13.7 | 14.4 | 13.7 | 9.03 | 8.59 | 8.81 |
| 2 ⁹⁾ | | | | | | |
| Rheology Agent | 0.20 | 0.20 | 0.19 | 0.25 | 0.24 | 0.25 |
| 3 ¹⁰⁾ | | | | | | |
| anti-popping | 0.02 | 0.02 | 0.02 | 0.02 | 0.02 | 0.02 |
| additive ¹¹⁾ | | | | | | |
| flow additive ¹²⁾ | 0.14 | 0.14 | 0.14 | 0.15 | 0.14 | 0.15 |
| Tin Catalyst ¹³⁾ | 0.19 | 0.19 | 0.18 | — | — | — |
| Acid Catalyst ¹⁴⁾ | 2.8 | 2.8 | 2.7 | 2.7 | 2.6 | 2.7 |
| Solvent ¹⁵⁾ | 9.4 | 5.3 | 8.2 | 4.6 | 9.7 | 4.5 |
| Gloss retention | 78.6 | 90.5 | 86.4 | 69.5 | 91.5 | 87.1 |
| [%] | | | | | | |

*inventive

5.3.1 Results of Chip Test and BAAT Test

The results obtained for the chip test and the BAAT test of clearcoat layers produced according to point 5.1 are listed in Table 9 (footnotes of Table 9 correspond to the footnotes of Table 6)

TABLE 9
Results of chip test and BAAT test for comparative and inventive
multilayer coatings MC prepared according to point 5.1

| | Multilayer coating | | |
|---|---|---|---|
| | MC4 | MC5* | MC6* |
| Clearcoat composition | C-C3 | C-I2 | C-I3 |
| Binder B-I2 | — | — | — |
| Binder B-I5 | — | 35.2 | — |
| Binder B-I6 | — | — | 38.9 |
| Binder B-C1 | 37.6 | — | — |
| Carbamate functional oligomer | 14.0 | 13.1 | 13.5 |
| Fumed silica dispersion ¹⁾ | — | — | — |
| Epoxy acrylic resin ²⁾ | — | — | — |
| Acrylic Resin ³⁾ | — | — | — |
| Melamine resin ⁴⁾ | 8.9 | 8.9 | 9.2 |
| Isocyanate crosslinker ⁵⁾ | — | — | — |
| UV absorber ⁶⁾ | 4.3 | 4.1 | 4.2 |
| HALS ⁷⁾ | 0.53 | 0.51 | 0.52 |
| Rheology Agent 1 ⁸⁾ | 17.9 | 17.0 | 17.4 |
| Rheology Agent 2 ⁹⁾ | 9.03 | 8.59 | 8.81 |
| Rheology Agent 3 ¹⁰⁾ | 0.25 | 0.24 | 0.25 |
| anti-popping additive ¹¹⁾ | 0.02 | 0.02 | 0.02 |
| flow additive ¹²⁾ | 0.15 | 0.14 | 0.15 |
| Tin Catalyst ¹³⁾ | — | — | — |
| Acid Catalyst ¹⁴⁾ | 2.7 | 2.6 | 2.7 |
| Solvent ¹⁵⁾ | 4.6 | 9.7 | 4.5 |
| Chip test room temperature | 1.49/5B | 1.25/6B | 1.54/6C |
| [% removed area]/rating | | | |
| Chip test freezer [% removed | 1.01/5B | 0.85/6B | 0.8/6B |
| area]/rating | | | |
| BAAT test rating | 3 | 2 | 3 |

*inventive

6. Discussion of Results

6.1 Physical Properties

The inventive clearcoat layers CL-I1 to CL-I3 prepared from inventive coating compositions C-I1 to C-I3 have an improved flexibility (i.e. strain at break, E′ at break) compared to comparative clearcoat layers CL-C1 and CL-C2 prepared from comparative coating compositions C-C1 and C-C3 not comprising a carbamate-functional ethylene copolymer. Without wishing to be bound to this theory, the improved flexibility is believed to be due to the longer bonding bath between the crosslinks in the carbamate-functional ethylene copolymers. Surprisingly, the improved flexibility does not negatively impair the hardness of the inventive clearcoat layers. In contrast, the use of a carbamate-functional ethylene copolymer in the inventive coating layers also results in improved hardness.

6.2 Gloss Retention

The inventive multilayer coatings MC3, MC5 and MC6 being prepared by using the inventive clearcoat compositions C-I1 to C-I3 comprising different carbamate-functional ethylene copolymers each have a significantly improved gloss retention compared to the comparative multilayer coatings MC1 and MC4 being prepared by using a carbamate-functional acrylate resin. Without wishing to be bound to this theory it is believed that the higher gloss retention arising from the use of the carbamate-functional ethylene copolymer is due to the fact that the ethylene units are almost 100 atom % along the bond path (except for those ethylene units at the end of the polymer chain beyond the last reactive group) while the carbamate-functional acrylic binder has a high percentage of aliphatic ester chains which do not contribute effective atoms in the crosslinked network, thus resulting in brittle films. The gloss retention achieved by using different carbamate-functional ethylene copolymers in inventive multilayer coatings MC3, MC5 and MC6 is comparable to the gloss retention achieved by incorporating a fumed silica dispersion into the clearcoat composition (see multilayer coating MC2)

6.3 Chip Test and BAAT Test

The use of a carbamate-functional ethylene copolymer in clearcoat compositions results in comparable or improved chipping resistance and acid resistance (MC4, MC5) as compared to multilayer coating MC3 being prepared from a clearcoat composition comprising a carbamate-functional acrylate resin. In conclusion, the use of carbamate-functional ethylene copolymer in clearcoat compositions allows to improve the mechanical properties as well as the gloss retention without negatively influencing the resistance of the obtained clearcoat layer against stone chipping and acidic treatment.

1. A coating composition comprising:
a) at least one binder B containing at least one carbamate group, said binder B being prepared by reacting at least one ethylene copolymer EC with at least one carbamate compound in the presence of at least one catalyst, said ethylene copolymer EC comprising:
in polymerized form—
i. 10 to 80 wt. % of ethylene;
ii. 1 to 90 wt. % of at least one polymerizable compound C1 having at least one hydroxyl group; and
iii. 0 to 80 wt. % of at least one further polymerizable compound C2 being different from compound C1; and
b) at least one crosslinking agent CA.

2. The coating composition according to claim 1, wherein the ethylene copolymer EC comprises—in polymerized form and based in each case on the total weight of the ethylene copolymer—from 20 to 70 wt. % of ethylene, as determined by ¹H-NMR.

3. The coating composition according to claim 1, wherein the at least one polymerizable compound C1 comprising at least one hydroxyl group is selected from the group consisting of hydroxyl group-containing (meth)acrylates.

4. The coating composition according to claim 1, wherein the ethylene copolymer EC comprises—in polymerized form and based in each case on the total weight of the ethylene copolymer EC—from 1 to 70 wt. % of at least one polymerizable compound C1 comprising at least one hydroxyl group, as determined by ¹H-NMR.

5. The coating composition according to claim 1, wherein the at least one polymerizable compound C2 is selected from the group consisting of alkyl (meth)acrylates.

6. The coating composition according to claim 1, wherein the ethylene copolymer EC comprises—in polymerized form and based in each case on the total weight of the ethylene copolymer EC—from 5 to 75 wt. % of at least one polymerizable compound C2, as determined by ¹H-NMR.

7. The coating composition according to claim 1, wherein the carbamate functional compound is a carbamate compound of general formula (I)

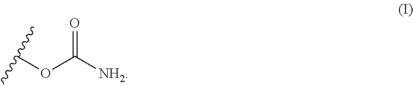

8. The coating composition according to claim 1, wherein the carbamate functional compound is an alkyl carbamate.

9. The coating composition according claim 8, wherein the alkyl carbamate is selected from the group consisting of methyl carbamate, ethyl carbamate, n-propyl carbamate, isopropyl carbamate, n-butyl carbamate, isobutyl carbamate, tert-butyl carbamate, n-hexyl carbamate, 2-ethylhexyl carbamate, cyclohexyl carbamate, phenyl carbamate, and mixtures thereof.

10. The coating composition according to claim 1, wherein the at least one carbamate compound is reacted with the ethylene copolymer EC in a molar ratio of carbamate compound to hydroxyl groups present in the ethylene copolymer EC of 10:1 to 1:1.

11. The coating composition according to claim 1, wherein the at least one catalyst is selected from the group consisting of tin containing catalysts, titanium (IV) alkoxides, zirconium (IV) acetylacetonate and mixtures thereof.

12. The coating composition according to claim 1, wherein the at least one catalyst is used in a total amount of 0.01 to 2 wt. %, based on the total amount of the ethylene copolymer EC and the carbamate compound.

13. The coating composition according to claim 1, wherein the coating composition comprises the at least one binder B containing at least one carbamate group in a total amount of 0.1 to 50 wt. % solids, based on the total weight of the coating composition.

14. A method for producing at least one coating on a substrate, comprising:
(1) optionally applying a pigmented basecoat composition to the substrate, forming a coating film from said basecoat composition and optionally curing said basecoat film;
(2) applying a coating composition as claimed in claim 1 to the substrate or the coated substrate obtained after step (1);
(3) forming a coating film from the composition applied in step (2); and
(4) curing the coating film(s) obtained after step (1) and/or (3).

15. A method of using the coating composition of claim 1, the method comprising using the coating composition for improving the scratch resistance of coating layers.

16. The coating composition according to claim 1, wherein the ethylene copolymer EC comprises—in polymerized form and based on the total weight of the ethylene copolymer—from 25 to 65 wt. %, of ethylene, as determined by ¹H-NMR.

17. The coating composition according to claim 1, wherein the ethylene copolymer EC comprises—in polymerized form and based on the total weight of the ethylene copolymer—from 30 to 55 wt. %, of ethylene, as determined by ¹H-NMR.

18. The coating composition according to claim 1 wherein the at least one polymerizable compound C1 comprising at least one hydroxyl group is selected from the group consisting of hydroxy C₁-C₁₂ alkyl group-containing (meth)acrylates.

19. The coating composition according to claim 1, wherein the at least one polymerizable compound C1 comprising at least one hydroxyl group is selected from the group consisting of 2-hydroxyethyl (meth)acrylate, 2-hydroxyisopropyl (meth)acrylate, 3-hydroxypropyl (meth)acrylate, hydroxyisobutyl (meth)acrylate and 4-hydroxybutyl (meth)acrylate.

20. The coating composition according to claim 1, wherein the at least one polymerizable compound C1 comprising at least one hydroxyl group is selected from the group consisting of 2-hydroxyethyl (meth)acrylate.
